(19) United States
(12) Patent Application Publication
(10) Pub. No.: US 2024/0077120 A1
(43) Pub. Date: Mar. 7, 2024

(54) DISC BRAKE DEVICE AND METHOD FOR ASSEMBLING SAME

(71) Applicant: AKEBONO BRAKE INDUSTRY CO., LTD., Tokyo (JP)

(72) Inventors: Ken MATSUBARA, Tokyo (JP); Yuta YAMAGUCHI, Tokyo (JP); Makoto MORIMOTO, Tokyo (JP)

(73) Assignee: AKEBONO BRAKE INDUSTRY CO., LTD., Tokyo (JP)

(21) Appl. No.: 18/239,963

(22) Filed: Aug. 30, 2023

(30) Foreign Application Priority Data
Sep. 5, 2022 (JP) 2022-140580

(51) Int. Cl. F16D 55/226; B60T 13/74; F16D 65/18

(52) U.S. Cl. CPC F16D 55/226; B60T 13/746; F16D 65/183; F16D 2121/24

(57) ABSTRACT

There is provided a disc brake device in which a plurality of annular seals that are disposed coaxially with rotation members, in which the annular seals are sandwiched in an axial direction between a caliper and a housing, and in which a position restriction portion includes: at least one caliper-side restriction portion provided on the caliper, which is disposed non-coaxially with the rotation member and is configured to serve as a reference of a position of the rotation member; and at least one housing-side restriction portion provided on the housing, which is disposed non-coaxially with an output member and is configured to serve as a reference of a position of the output member, and is configured to restrict a position of the housing with respect to the caliper by bringing the caliper-side restriction portion and the housing-side restriction portion into contact with each other.

### CROSS-REFERENCE TO RELATED APPLICATIONS

This application is based on Japanese Patent Application No. 2022-140580 filed on Sep. 5, 2022, the contents of which are incorporated herein by way of reference.

### TECHNICAL FIELD

The present disclosure relates to a disc brake device and a method for assembling the same.

### BACKGROUND

There are increasing cases where a disc brake device is adopted not only for front wheels but also for rear wheels of an automobile because the disc brake device is excellent in heat dissipation and a braking force during traveling can be finely adjusted.

Disc brake devices can be roughly divided into hydraulic disc brake devices that use hydraulic oil to obtain a braking force and electric disc brake devices that use an electrically drivable actuator to obtain a braking force.

As disclosed in JP2020-118166A (Patent Literature 1) and the like, as an electric disc brake device, there is an electric parking brake structure in which a braking force caused by a service brake is generated by feeding brake oil (fluid) into a cylinder, and a braking force caused by a parking brake is generated by driving an electric actuator such as a rotation-linear motion conversion mechanism by an electric motor.

FIG. 26 illustrates an electric parking disc brake device 100 disclosed in JP2020-118166A.

The disc brake device 100 is a floating-type disc brake device, and includes a support 101 fixed to a suspension device, and a caliper 102 supported so as to be movable in an axial direction of a rotor (not illustrated) with respect to the support 101.

Each of an outer pad 103a and an inner pad 103b is supported by the support 101 so as to be movable in the axial direction of the rotor.

The caliper 102 includes a cylinder 104. A piston 105 is fitted into an inner side of the cylinder 104.

A rotation-linear motion conversion mechanism 106 that presses the piston 105 when a braking force caused by the parking brake is obtained is disposed in an inner side of the piston 105. The rotation-linear motion conversion mechanism 106 includes a spindle 107 as a rotation member and a nut 108 as a linear motion member. The rotation-linear motion conversion mechanism 106 is driven by the motor gear unit 109.

The motor gear unit 109 includes a housing 110, an electric motor (not illustrated), and an output shaft 111.

The housing 110 is fixed to the caliper 102 by bolts (not illustrated), and accommodates the electric motor, the output shaft 111, and the like.

The output shaft 111 is disposed coaxially with the spindle 107 constituting the rotation-linear motion conversion mechanism 106, and is connected to an end portion of the spindle 107 in a torque transmittable manner. A final gear constituting a deceleration mechanism such as a gear type reduction gear is fixed to the output shaft 111. Therefore, the output shaft 111 is rotationally driven by the electric motor to transmit rotation of the electric motor to the spindle 107.

Sealing is performed between the caliper 102 and the housing 110 by an O-ring 112. The O-ring 112 is disposed in a spigot-fitting portion 113 between the caliper 102 and the housing 110. Specifically, the O-ring 112 is sandwiched between an outer peripheral surface of a fitting shaft portion 114 provided in the caliper 102 and an inner peripheral surface of a fitting hole portion 115 provided in the housing 110 in a radial direction of the spigot-fitting portion 113.

In the disc brake device 100 of an existing structure, the fitting shaft portion 114 and the spindle 107 are coaxially disposed, and the fitting hole portion 115 and the output shaft 111 are coaxially disposed. As a result, by spigot-fitting the fitting shaft portion 114 and the fitting hole portion 115, positioning of the housing 110 with respect to the caliper 102 is performed, and coaxiality between the spindle 107 and the output shaft 111 is ensured.

When the service brake is caused to operate by the disc brake device 100 of the existing structure, the brake oil is fed to the cylinder 104 provided in the caliper 102 through an oil passage (not illustrated). As a result, the piston 105 is pushed out from the cylinder 104 and the inner pad 103b is pressed against an inner surface of the rotor. In addition, the caliper 102 is displaced toward an inner side with respect to the support 101 in the axial direction of the rotor by a reaction force caused by the pressing. Further, the outer pad 103a is pressed against an outer surface of the rotor by the caliper 102. As a result, a braking force is obtained by friction applied to contact surfaces of the outer pad 103a and the inner pad 103b with the rotor.

On the other hand, in order to cause the parking brake to operate by the disc brake device 100, the electric motor is rotationally driven in a predetermined direction to rotate the output shaft 111. When rotation is transmitted to the output shaft 111, the piston 105 is pushed out toward the rotor via the rotation-linear motion conversion mechanism 106 to press the inner pad 103b against the inner surface of the rotor. In addition, the caliper 102 is displaced toward an inner side with respect to the support 101 in the axial direction of the rotor by a reaction force caused by the pressing. Further, the outer pad 103a is pressed against an outer surface of the rotor by the caliper 102. As a result, a braking force caused by the parking brake is obtained by friction applied to the contact surfaces of the outer pad 103a and the inner pad 103b with the rotor.
Patent Literature 1: JP2020-118166A
Patent Literature 2: U.S. Patent Application Publication No. 2020/0309214

As disclosed in U.S. Patent Application Publication No. 2020/0309214 (Patent Literature 2), in an electric parking disc brake device mounted on a large vehicle such as a truck or a commercial vehicle, in order to obtain a large braking force, a pad is simultaneously pressed by a plurality of pistons.

In the electric parking disc brake device having a configuration in which a pad is simultaneously pressed by a plurality of pistons, rotation members constituting a rotation-linear motion conversion mechanism disposed on an inner side of each of a plurality of cylinders and a plurality of output members accommodated in a housing of a motor gear unit need to be disposed coaxially with each other and connected to each other in a torque transmittable manner.

In order to coaxially dispose the plurality of rotation members and the plurality of output members, it is conceivable to use a spigot-fitting portion as in the existing structure disclosed in JP2020-118166A. Specifically, it is conceivable that the same number of spigot-fitting portions as the number of the rotation members and the output members are provided, and for each spigot-fitting portion, a fitting shaft portion and a rotation member are coaxially disposed, and a fitting hole portion and an output member are coaxially disposed.

However, when a plurality of spigot-fitting portions are provided, it is difficult to strictly match a size of a clearance between an outer peripheral surface of the fitting shaft portion and an inner peripheral surface of the fitting hole portion in all the spigot-fitting portions. Therefore, positioning of the housing with respect to the caliper is performed based on a spigot-fitting portion having the smallest clearance. Accordingly, it is possible to ensure the coaxiality between the rotation member and the output member whose positions are restricted with reference to the spigot-fitting portion having the smallest clearance, but it is difficult to ensure the coaxiality between the rotation member and the output member whose positions are restricted with reference to another spigot-fitting portion. As a result, there is a possibility of causing a problem such as a reduction in conversion efficiency of the rotation-linear motion conversion mechanism.

In a case where a configuration in which an O-ring is sandwiched in the radial direction of the spigot-fitting portion is adopted for each of the plurality of spigot-fitting portions, it is difficult to make interference of the O-ring uniform over the entire circumference for the spigot-fitting portions other than the spigot-fitting portion having the smallest clearance. Therefore, it is difficult to ensure sealing performance between the caliper and the housing.

The present disclosure has been made to solve the above problem, and an object thereof is to provide a disc brake device capable of ensuring coaxiality between a plurality of rotation members and a plurality of output members and capable of ensuring sealing performance between a caliper and a housing.

### SUMMARY

A disc brake device according to an aspect of the present disclosure includes a caliper, a plurality of pistons, a plurality of rotation-linear motion conversion mechanisms, a motor gear unit, a plurality of annular seals, a position restriction portion, and a fixing portion.

The caliper has a plurality of cylinders on an inner side in an axial direction with respect to a rotor.

The plurality of pistons are fitted into the plurality of cylinders, respectively. The plurality of rotation-linear motion conversion mechanisms are disposed in the plurality of cylinders, configured to push out each of the plurality of pistons toward the rotor by converting a rotational motion into a linear motion, and include rotation members and linear motion members.

The motor gear unit is supported and fixed to the caliper and includes an electric motor, a plurality of output members disposed coaxially with the rotation members and configured to transmit rotation of the electric motor to the rotation members, the number of which is the same as the number of the rotation members, and a housing accommodating the electric motor and the plurality of output members.

The plurality of annular seals are provided in the same number as the number of the rotation members, are disposed coaxially with the rotation members, and configured to perform sealing between the caliper and the housing.

The position restriction portion is configured to restrict a position of the motor gear unit with respect to the caliper.

The fixing portion is configured to fix the caliper and the housing.

In the disc brake device according to the aspect of the present disclosure, the annular seals are sandwiched in the axial direction between the caliper and the housing.

The position restriction portion includes: at least one caliper-side restriction portion provided on the caliper, which is disposed non-coaxially with the rotation member and is configured to serve as a reference of a position of the rotation member: and at least one housing-side restriction portion provided on the housing, which is disposed non-coaxially with the output member and is configured to serve as a reference of a position of the output member, and is configured to restrict a position of the housing with respect to the caliper by bringing the caliper-side restriction portion and the housing-side restriction portion into contact with each other.

In the disc brake device according to the aspect of the present disclosure, the caliper-side restriction portion may include at least one caliper-side restriction surface having a curved surface shape or a flat surface shape, and the housing-side restriction portion may include at least one housing-side restriction surface having a curved surface shape or a flat surface shape.

The caliper-side restriction portion and the housing-side restriction portion can be brought into contact with each other by the caliper-side restriction surface and the housing-side restriction surface.

In the disc brake device according to the aspect of the present disclosure, one of the caliper-side restriction portion and the housing-side restriction portion may include at least one restriction corner portion, and the other of the caliper-side restriction portion and the housing-side restriction portion may include at least one restriction surface having a curved surface shape or a flat surface shape.

The caliper-side restriction portion and the housing-side restriction portion can be brought into contact with each other by the restriction corner portion and the restriction surface.

In the disc brake device according to the aspect of the present disclosure, the caliper-side restriction portion and the housing-side restriction portion may be provided in two each.

In the disc brake device according to the aspect of the present disclosure, by bringing a first caliper-side restriction portion of the two caliper-side restriction portions into contact with a first housing-side restriction portion of the two housing-side restriction portions, a circumferential position and a radial position of each of the first caliper-side restriction portion and the first housing-side restriction portion may be restricted, and by bringing a second caliper-side restriction portion of the two caliper-side restriction portions into contact with a second housing-side restriction portion of the two housing-side restriction portions, a relative rotation position between the caliper and the housing about a central axis of the first caliper-side restriction portion or the first housing-side restriction portion may be restricted.

In the disc brake device according to the aspect of the present disclosure, a contact direction of the second caliper-side restriction portion and the second housing-side restriction portion may be a circumferential direction or a radial direction.

In the disc brake device according to the aspect of the present disclosure, the caliper-side restriction portion may have a convex shape protruding in the axial direction.

In this case, the caliper-side restriction portion may be formed separately from the caliper, and may include a pin member configured to be fixed to the caliper.

Further, when the caliper-side restriction portion is formed separately from the caliper, the caliper-side restriction portion may be sandwiched and disposed between the caliper and the housing in the axial direction.

In the disc brake device according to the aspect of the present disclosure, the housing-side restriction portion may be formed integrally with the housing.

In this case, the housing-side restriction portion may be provided in a part of a reinforcing rib integrally formed with the housing.

In addition, when the housing-side restriction portion is integrally formed with the housing, the housing-side restriction portion may have a concave shape recessed in the axial direction.

In the disc brake device according to the aspect of the present disclosure, the housing-side restriction portion may be formed separately from the housing and may include a pin member configured to be molded and fixed to the housing.

In the disc brake device according to the aspect of the present disclosure, the fixing portion may be a bolt.

A method for assembling the disc brake device according to the aspect of the present disclosure includes a process of, when the disc brake device according to the aspect of the present disclosure is to be assembled, bringing the caliper-side restriction portion and the housing-side restriction portion into contact with each other by utilizing gravity applied to the housing or the caliper.

A method for assembling the disc brake device according to the aspect of the present disclosure includes a process of, when the disc brake device according to the aspect of the present disclosure in which a bolt is adopted as the fixing portion is to be assembled, bringing the caliper-side restriction portion and the housing-side restriction portion into contact with each other by utilizing a rotational force applied to the housing or the caliper from the bolt when tightening the bolt.

### BRIEF DESCRIPTION OF DRAWINGS

FIG. 1 is a front view of a disc brake device according to a first example of an embodiment as viewed from an outer side (outer side of a vehicle body) in an axial direction.

FIG. 2 is a rear view of the disc brake device according to the first example of the embodiment as viewed from an inner side (center side of the vehicle body) in the axial direction.

FIG. 3 is a plan view of the disc brake device according to the first example of the embodiment as viewed from an outer side in a radial direction.

FIG. 4 is a bottom view of the disc brake device according to the first example of the embodiment as viewed from an inner side in the radial direction.

FIG. 5 is a perspective view of the disc brake device according to the first example of the embodiment as viewed from the outer side in the axial direction and the outer side in the radial direction.

FIG. 6 is a cross-sectional view taken along a line A-A in FIG. 1.

FIG. 7 is a partial enlarged view of FIG. 6.

FIG. 8 is a partially cutaway side view of the disc brake device according to the first example of the embodiment as viewed from one side in a circumferential direction.

FIG. 9 is a partial enlarged view of FIG. 8.

FIG. 10 is a rear view of the disc brake device according to the first example of the embodiment as viewed from the inner side in the axial direction in a state where a motor gear unit is removed.

FIG. 11 is a perspective view of the disc brake device according to the first example of the embodiment as viewed from the inner side in the axial direction and the outer side in the radial direction in the state where the motor gear unit is removed.

FIG. 12 is a front view of the motor gear unit constituting the disc brake device according to the first example of the embodiment when taken out and viewed from the outer side in the axial direction.

FIG. 13 is a perspective view of the motor gear unit constituting the disc brake device according to the first example of the embodiment when taken out and viewed from the outer side in the axial direction and the outer side in the radial direction.

FIG. 14 is a perspective view illustrating the motor gear unit constituting the disc brake device according to the first example of the embodiment when taken out, with a housing omitted.

FIG. 15 is a schematic view illustrating a deceleration mechanism constituting the disc brake device according to the first example of the embodiment.

FIG. 16 is a schematic cross-sectional view of a position restriction portion according to the first example of the embodiment.

FIG. 17 is a schematic cross-sectional view of a portion corresponding to a part of FIG. 9, illustrating a second example of the embodiment.

FIG. 18 is a schematic view illustrating a disc brake device according to a third example of the embodiment in a state where the motor gear unit is removed from a caliper.

FIG. 19 is a view corresponding to FIG. 16, illustrating a fourth example of the embodiment.

FIG. 20 is a view corresponding to FIG. 16, illustrating a fifth example of the embodiment.

FIG. 21 is a view corresponding to FIG. 16, illustrating a sixth example of the embodiment.

FIG. 22 is a view corresponding to FIG. 16, illustrating a seventh example of the embodiment.

FIG. 23 is a view corresponding to FIG. 16, illustrating an eighth example of the embodiment.

FIG. 24 is a view corresponding to FIG. 16, illustrating a ninth example of the embodiment.

FIG. 25 is a view corresponding to FIG. 16, illustrating a tenth example of the embodiment.

FIG. 26 is a cross-sectional view illustrating a disc brake device of an existing structure.

### DESCRIPTION OF EMBODIMENTS

### First Example of Embodiment

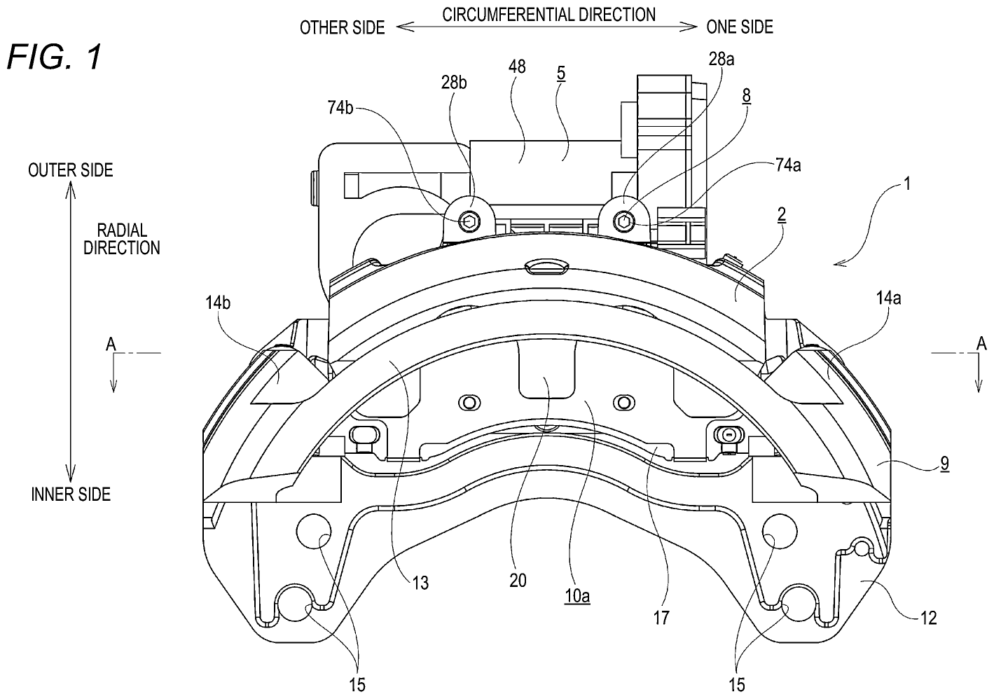

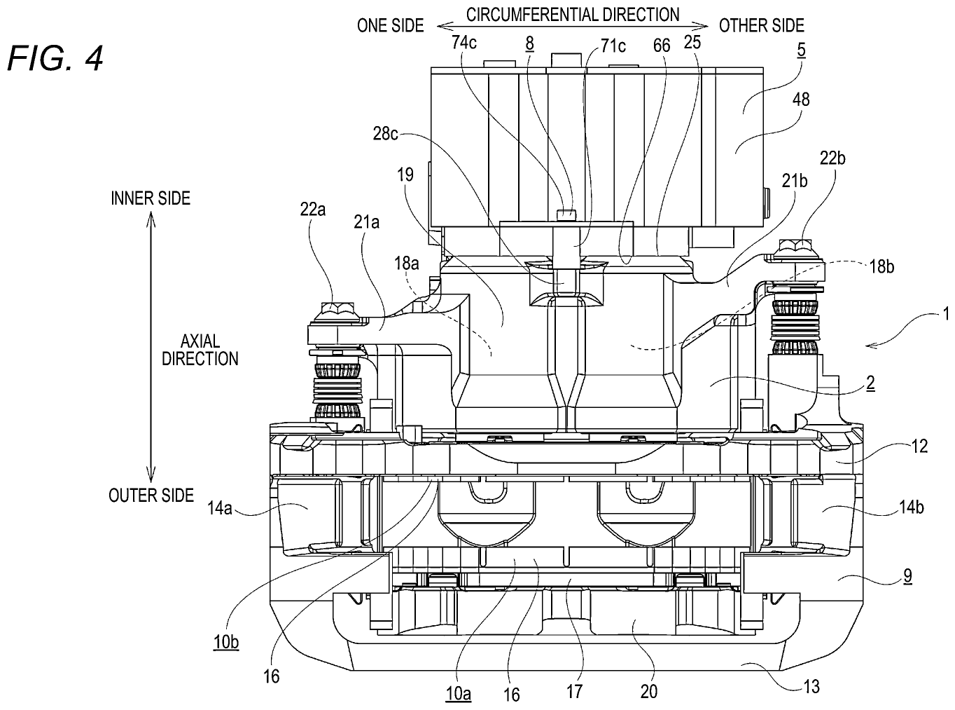

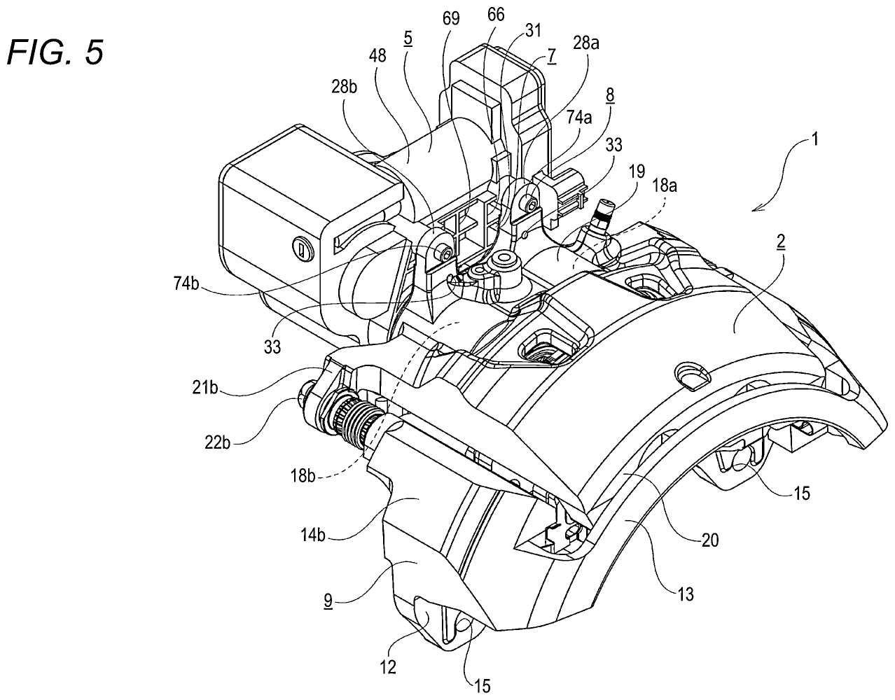

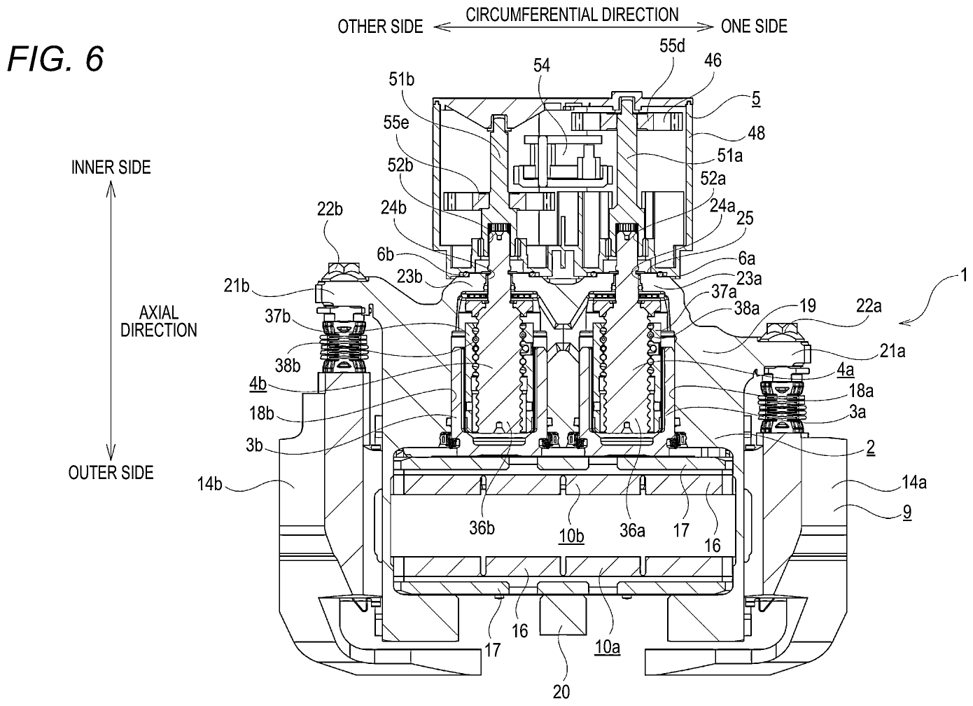

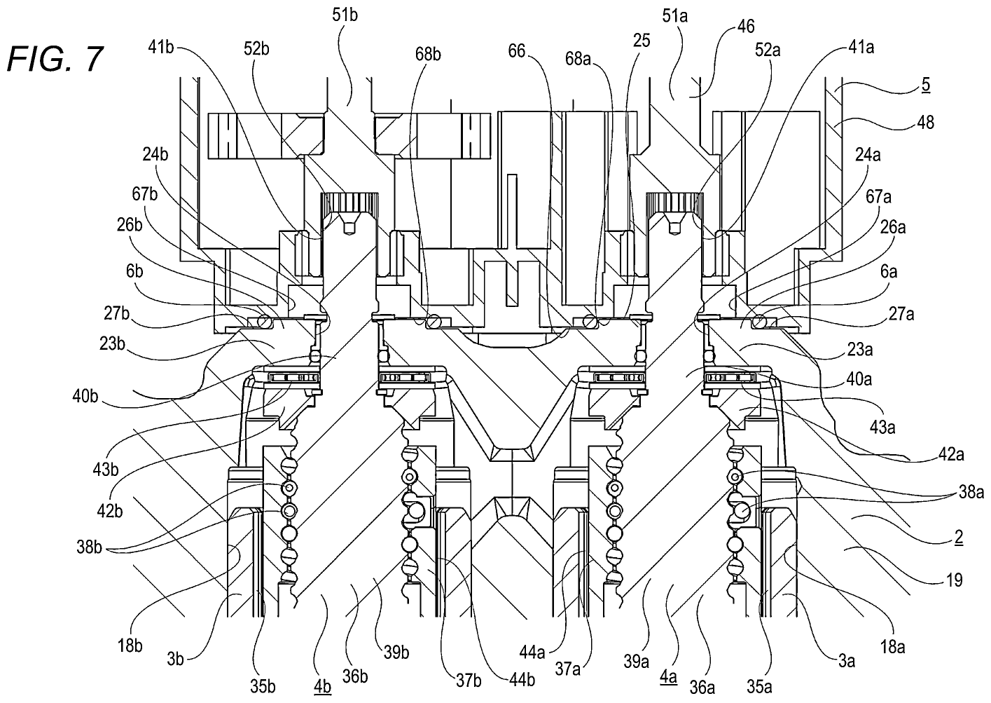

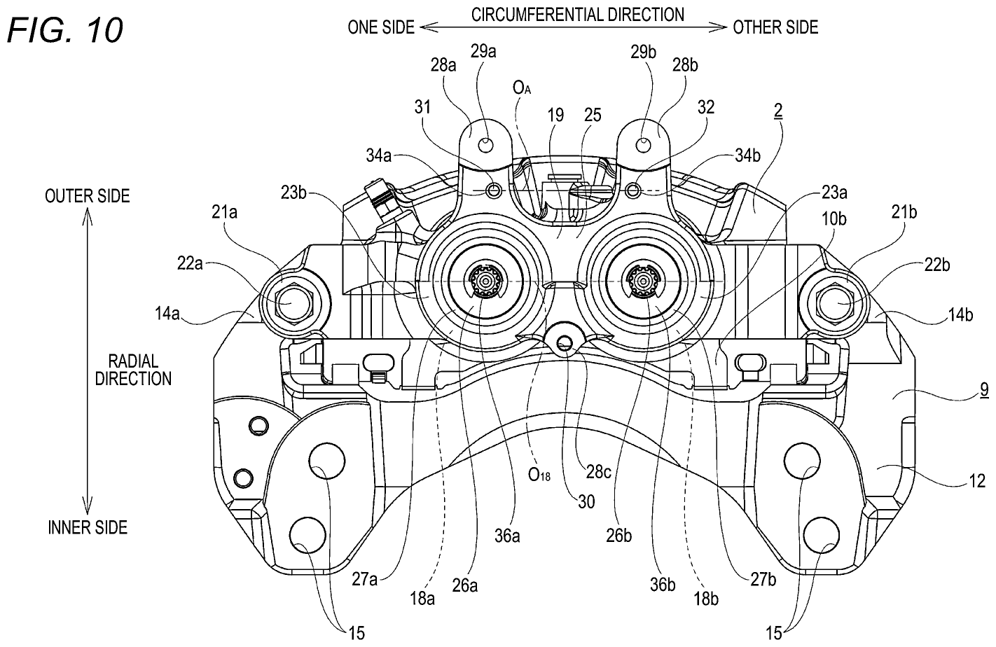

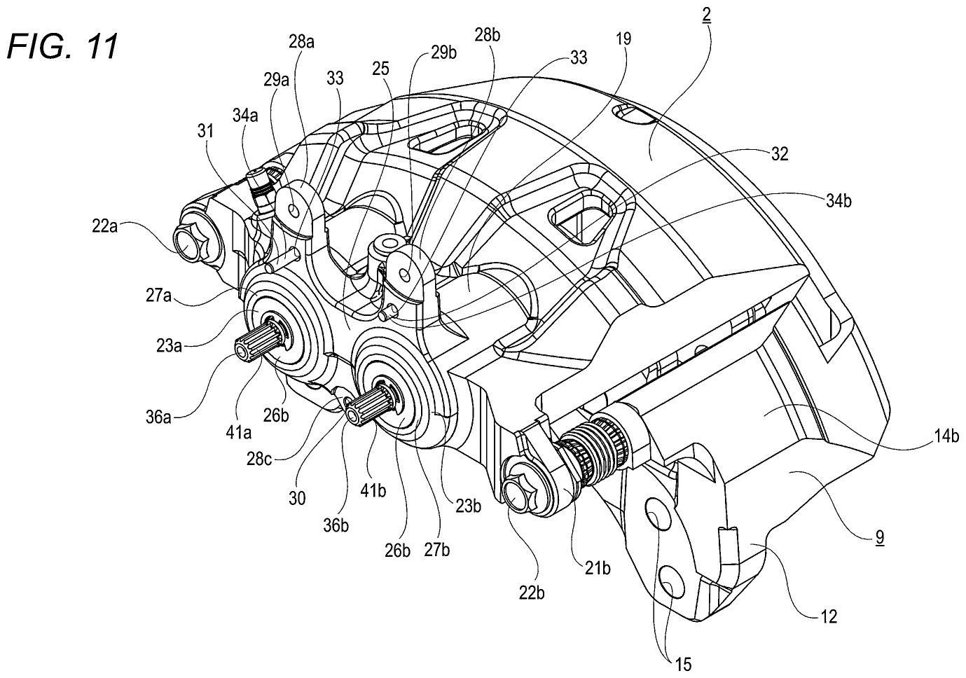

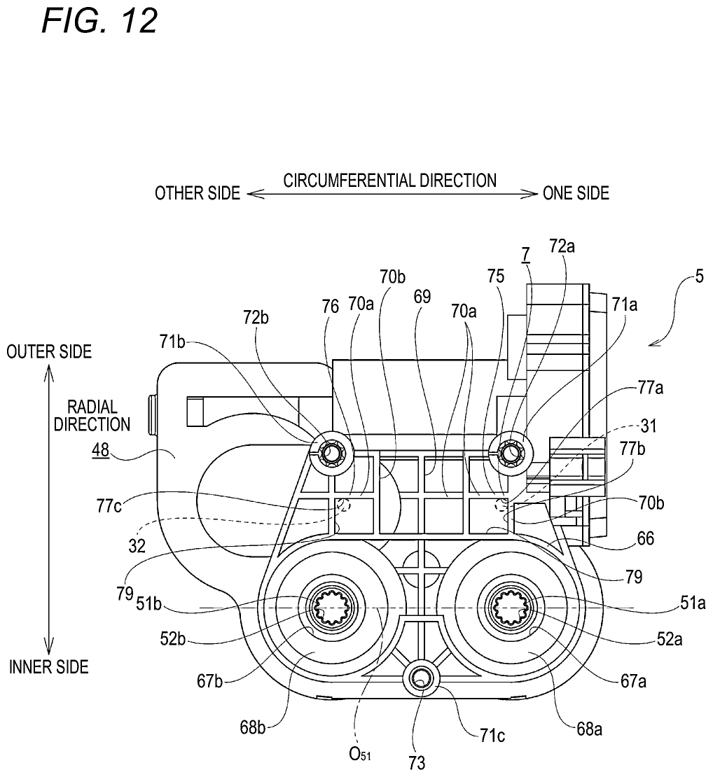

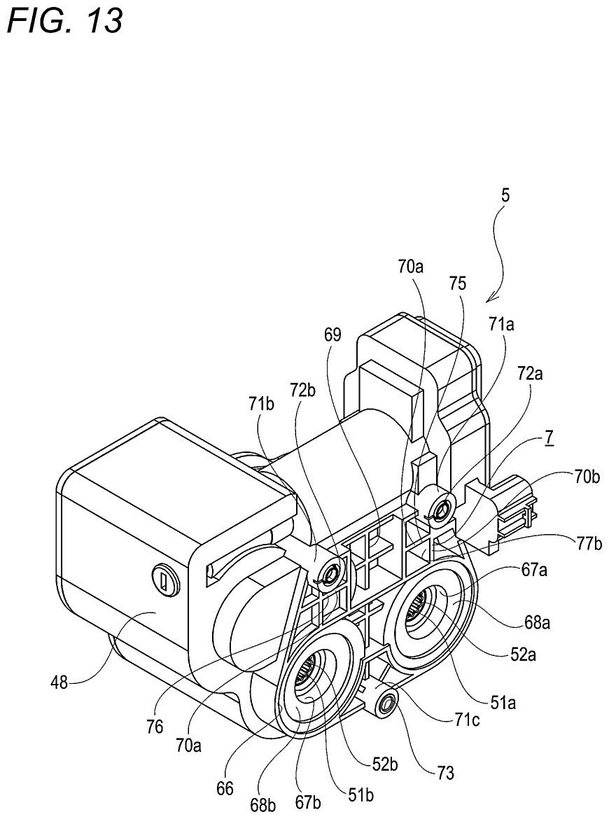

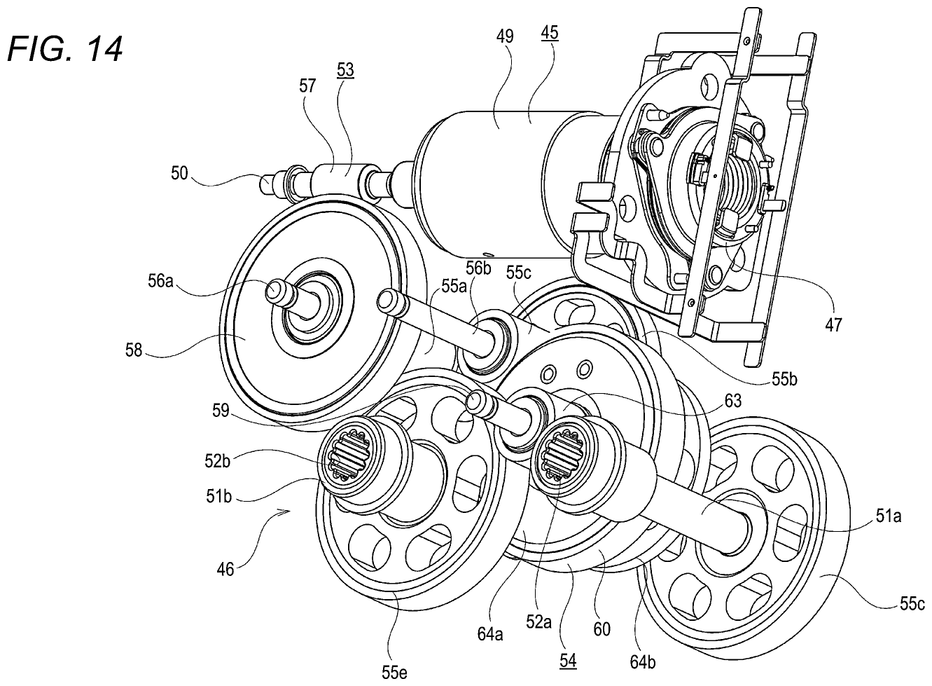

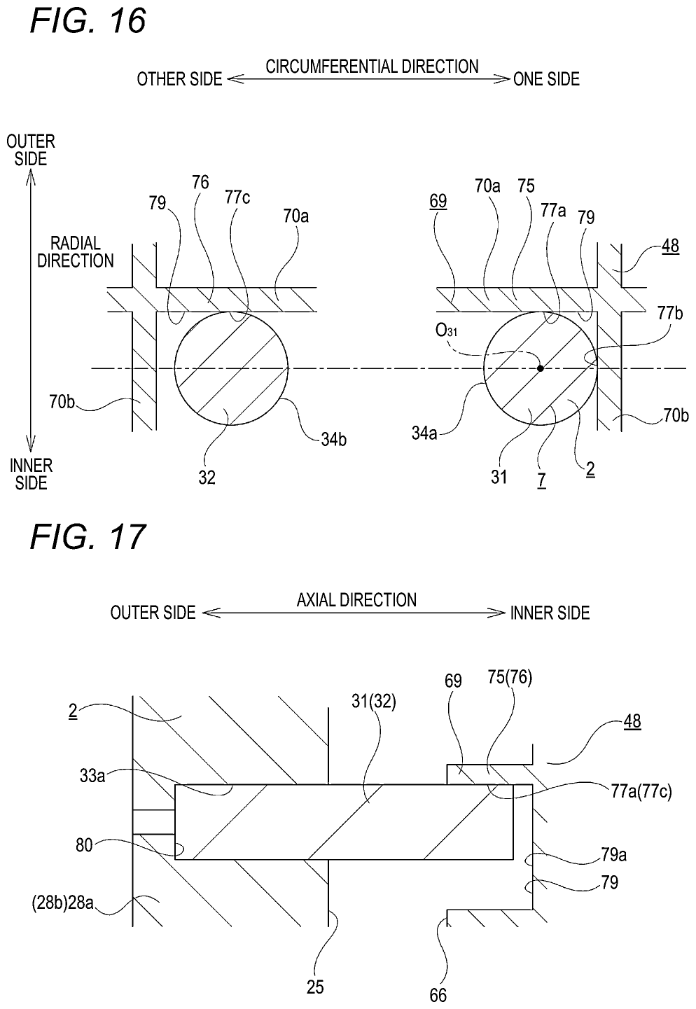

A first example of the embodiment will be described with reference to FIGS. 1 to 16.

[Overall Configuration of Disc Brake Device]

A disc brake device 1 according to the present example is an electric parking brake type disc brake device, and has both a function as a hydraulic service brake and a function as an electric parking brake.

The disc brake device 1 includes a caliper 2, a plurality of pistons 3a and 3b, a plurality of rotation-linear motion conversion mechanisms 4a and 4b, a motor gear unit 5, a plurality of annular seals 6a and 6b, a position restriction portion 7, and a fixing portion 8.

The disc brake device 1 according to the present example is a floating-type disc brake device, and further includes a support 9, an outer pad 10a, and an inner pad 10b.

The disc brake device 1 according to the present example is incorporated in a relatively large vehicle. Therefore, the disc brake device 1 includes two pistons 3a and 3b, two rotation-linear motion conversion mechanisms 4a and 4b, and two annular seals 6a and 6b, but may include three or more of those.

The disc brake device 1 obtains a braking force caused by a service brake by feeding brake oil (pressurized oil) as hydraulic oil to a first cylinder 18a and a second cylinder 18b provided in the caliper 2. On the other hand, the disc brake device 1 obtains a braking force caused by a parking brake by driving the rotation-linear motion conversion mechanisms 4a and 4b by the motor gear unit 5 without using the hydraulic oil.

The motor gear unit 5 is fixed to the caliper 2 by the fixing portion 8 in a state where a position of the motor gear unit 5 with respect to the caliper 2 is restricted by the position restriction portion 7. A space between a housing 48 (described later) constituting the motor gear unit 5 and the caliper 2 is sealed by the plurality of annular seals 6a and 6b. As described above, the disc brake device 1 according to the present example separately includes the position restriction portion 7 for restriction the position of the motor gear unit 5 with respect to the caliper 2 and the fixing portion 8 for fixing the motor gear unit 5 to the caliper 2.

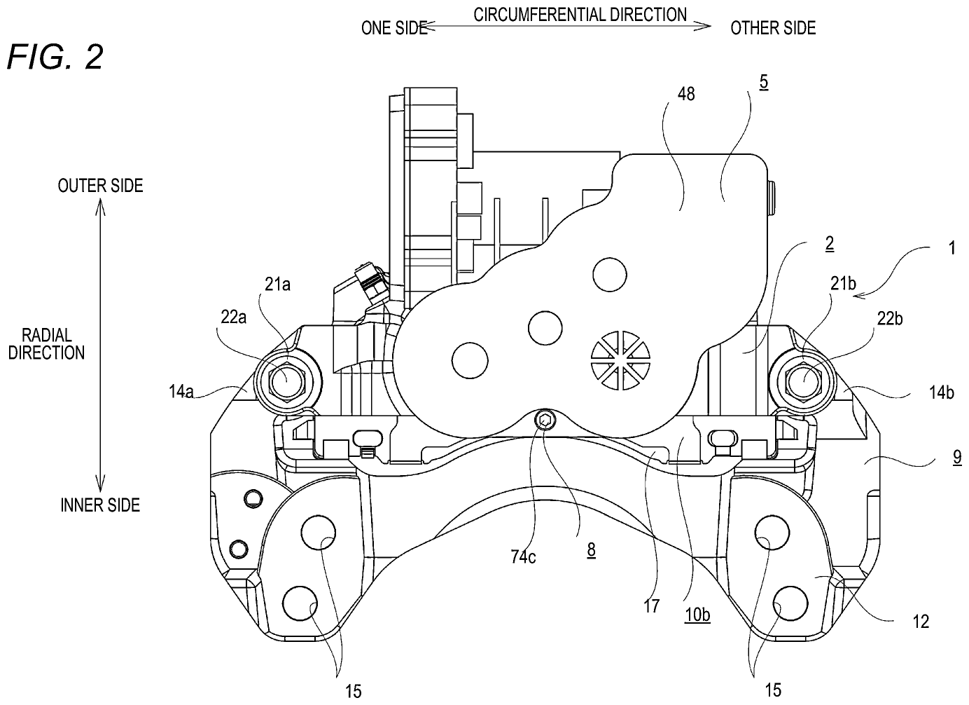

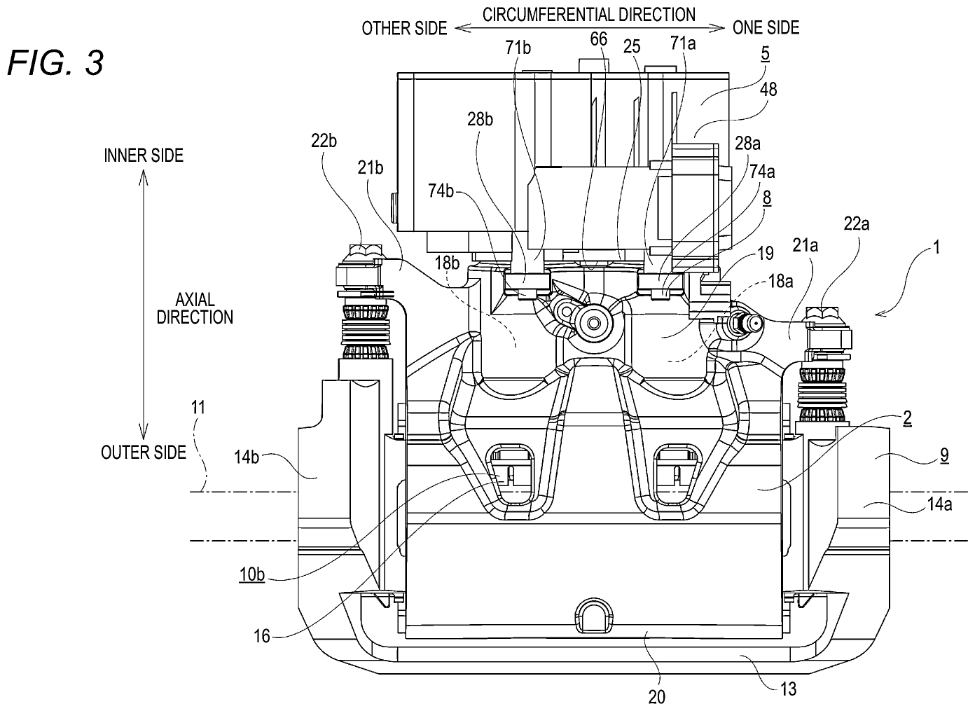

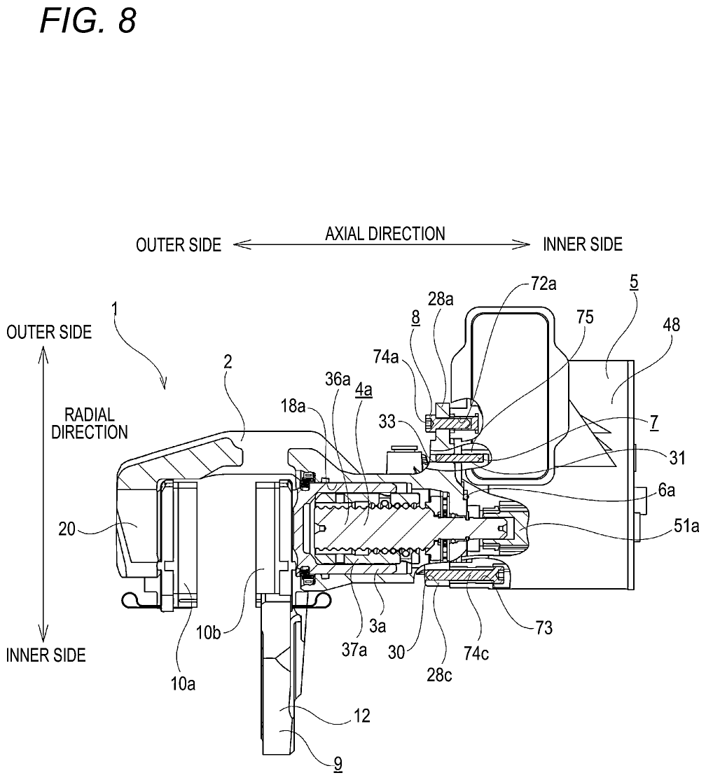

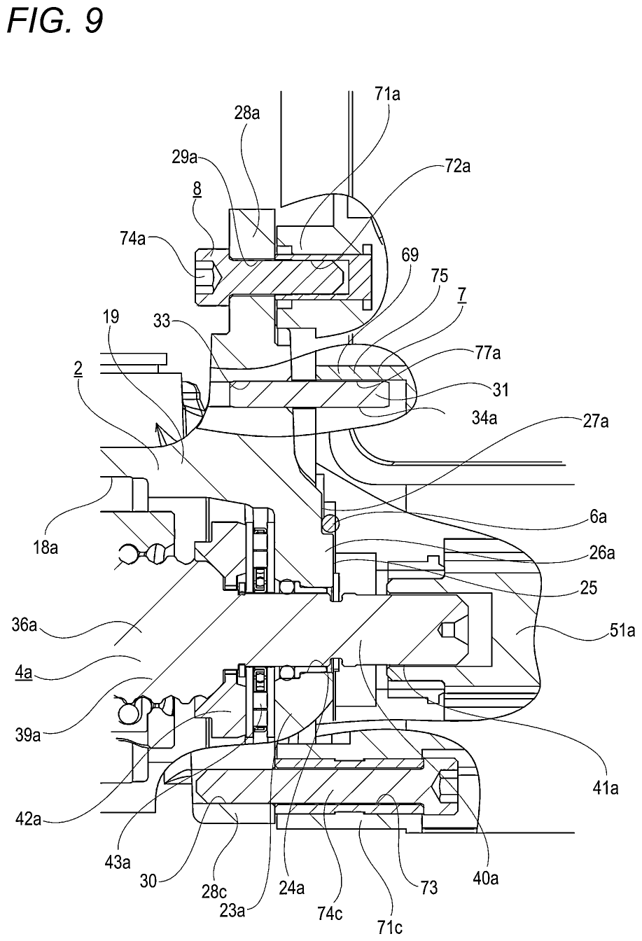

In the following description related to the disc brake device 1, unless otherwise specified, an axial direction, a circumferential direction, and a radial direction refer to an axial direction, a circumferential direction, and a radial direction of a disc-shaped rotor 11 (see FIG. 3) that rotates together with a wheel. A front-back direction in FIGS. 1, 2, 10, 12, and 16, an up-down direction in FIGS. 3, 4, 6, and 7, and a left-right direction in FIGS. 8 and 9 correspond to the axial direction, and a center side of a vehicle body in a state where the disc brake device 1 is attached to the vehicle body is referred to as an inner side in the axial direction, and an outer side of the vehicle body in the state where the disc brake device 1 is attached to the vehicle body is referred to as an outer side in the axial direction. A left-right direction in FIGS. 1 to 4, 6, 7, 10, 12, and 16 and a front-back direction in FIGS. 8 and 9 correspond to the circumferential direction. A right side in FIGS. 1, 3, 6, 7, 12, and 16 and a left side in FIGS. 2, 4, and 10 correspond to one side in the circumferential direction, and a left side in FIGS. 1, 3, 6, 7, 12, and 16 and a right side in FIGS. 2, 4, and 10 correspond to the other side in the circumferential direction. In addition, an up-down direction in FIGS. 1, 2, 8 to 10, 12, and 16 and a front-back direction in FIGS. 3, 4, 6, and 7 correspond to the radial direction, an upper side in FIGS. 1, 2, 8 to 10, 12, and 16 is an outer side in the radial direction, and a lower side in FIGS. 1, 2, 8 to 10, 12, and 16 is an inner side in the radial direction.

<Support>

The support 9 is a cast product of an iron-based alloy such as cast iron, and includes a support base 12 disposed on the inner side in the axial direction of the rotor 11, an outer connecting portion 13 disposed on the outer side in the axial direction of the rotor 11, and a pair of connecting arms 14a and 14b connecting, in the axial direction, end portions on both outer sides in the circumferential direction of the support base 12 and end portions on both outer sides in the circumferential direction of the outer connecting portion 13, respectively. A guide hole (not illustrated) that is open to the inner side in the axial direction is formed in a portion on the outer side in the radial direction of each of the connecting arms 14a and 14b. The support 9 is fixed to a suspension device constituting the vehicle body using a plurality of (four in the illustrated example) mounting holes 15 formed in a portion on the inner side in the radial direction of the support base 12.

In the disc brake device 1 according to the present example, in a state where the support 9 is fixed to the suspension device, the connecting arm 14a on one side in the circumferential direction is disposed on the upper side in the up-down direction, and the connecting arm 14b on the other side in the circumferential direction is disposed on the lower side in the up-down direction. However, an assembling direction of the disc brake device 1 is not particularly limited.

<Outer Pad and Inner Pad>

The outer pad 10a and the inner pad 10b are disposed on both sides in the axial direction of the rotor 11 so as to sandwich the rotor 11 from both sides in the axial direction. The outer pad 10a is disposed on the outer side in the axial direction of the rotor 11, and is supported so as to be displaceable in the axial direction with respect to the support 9. The inner pad 10b is disposed on the inner side in the axial direction of the rotor 11, and is supported so as to be displaceable in the axial direction with respect to the support 9.

Each of the outer pad 10a and the inner pad 10b includes a lining 16 and a metal back plate 17 supporting a back surface of the lining 16.

<Caliper>

The caliper 2 is made of an aluminum-based alloy or an iron-based alloy, and has an inverted U-shape as viewed from the circumferential direction.

The caliper 2 has a clamp base 19 including a plurality of cylinders 18a and 18b on the inner side in the axial direction with respect to the rotor 11, and has a pressing portion 20 on the outer side in the axial direction with respect to the rotor 11. The clamp base 19 and the pressing portion 20 are connected in the axial direction. In addition, the clamp base 19 has a pair of arms 21a and 21b on end portions on both sides in the circumferential direction.

The caliper 2 is supported so as to be displaceable in the axial direction with respect to the support 9 using guide pins 22a and 22b. Thus, end portions on the inner side in the axial direction of the guide pins 22a and 22b are fixed to the arms 21a and 21b, and end portions to intermediate portions on the outer side in the axial direction of the guide pins 22a and 22b are inserted into the inner side of the guide holes provided in the connecting arms 14a and 14b of the support 9 so as to be relatively displaceable in the axial direction.

In the present example, the caliper 2 has two cylinders of the first cylinder 18a and the second cylinder 18b.

Each of the first cylinder 18a and the second cylinder 18b is a substantially cylindrical space, and is open in an outer surface in the axial direction of the clamp base 19. End portions on the inner side in the axial direction of each of the first cylinder 18a and the second cylinder 18b are closed by bottom portions 23a and 23b. In this case, the bottom portions 23a and 23b are provided with insert-through holes 24a and 24b for allowing end portions on the inner side in the axial direction of spindles 36a and 36b (described later) to be inserted therethrough.

In the present example, the motor gear unit 5 is fixed to the inner side in the axial direction of the caliper 2. Therefore, the clamp base 19 has a housing facing surface 25 on an inner surface in the axial direction.

The insert-through holes 24a and 24b are open in the housing facing surface 25. In addition, annular convex portions 26a and 26b, which are disposed coaxially with central axes of the respective insert-through holes 24a and 24b and slightly protrude toward the inner side in the axial direction, are provided around the insert-through holes 24a and 24b within the housing facing surface 25. Further, circular ring surfaces 27a and 27b are provided around the annular convex portions 26a and 26b. The circular ring surface 27a is a flat surface existing on a virtual plane orthogonal to a central axis of the first cylinder 18a, and the circular ring surface 27b is a flat surface existing on a virtual plane orthogonal to a central axis of the second cylinder 18b.

In the present example, in order to fix the motor gear unit 5 to the caliper 2, a plurality of (three in the illustrated example) mounting flanges 28a to 28c are provided in the clamp base 19.

Among the mounting flanges 28a to 28c, two mounting flanges 28a and 28b provided on a portion on the outer side in the radial direction of the clamp base 19 are formed in a tongue-like plate shape. The mounting flanges 28a and 28b are disposed apart from each other in the circumferential direction and each extends toward the outer side in the radial direction.

The mounting flange 28a on one side in the circumferential direction is disposed on the outer side in the radial direction of the first cylinder 18a, and the mounting flange 28b on the other side in the circumferential direction is disposed on the outer side in the radial direction of the second cylinder 18b. Through holes 29a and 29b are provided in a portion on the outer side in the radial direction of the mounting flanges 28a and 28b, respectively. Mounting bolts 74a and 74b (described later) serving as the fixing portion 8 are loosely inserted into the through holes 29a and 29b, respectively, in the axial direction.

Among the mounting flanges 28a to 28c, one mounting flange 28c provided on a portion on the inner side in the radial direction of the clamp base 19 is formed in a triangular plate shape. The mounting flange 28c is disposed on a portion between the first cylinder 18a and the second cylinder 18b in the circumferential direction, and extends toward the inner side in the radial direction. The mounting flange 28c is provided with a female screw hole 30. A mounting bolt 74c (described later) serving as the fixing portion 8 is screwed into the female screw hole 30.

Inner surfaces in the axial direction of the respective mounting flanges 28a to 28c constitute the housing facing surface 25.

The caliper 2 has a plurality of caliper-side restriction portions 31 and 32 constituting the position restriction portion 7 in order to restrict the position of the motor gear unit 5 with respect to the caliper 2. In the present example, the caliper 2 has two caliper-side restriction portions of a first caliper-side restriction portion 31 and a second caliper-side restriction portion 32.

Each of the first caliper-side restriction portion 31 and the second caliper-side restriction portion 32 is formed of a pin member having a columnar shape, is formed separately from the caliper 2, and is fixed to the caliper 2. A diameter of each of the first caliper-side restriction portion 31 and the second caliper-side restriction portion 32 is constant over a total length. In the present example, the first caliper-side restriction portion 31 and the second caliper-side restriction portion 32 are parts having the same diameter but different total lengths, but common parts having the same total length as well as the same diameter may be used. In addition, parts having different diameters and total lengths may be used.

The first caliper-side restriction portion 31 and the second caliper-side restriction portion 32 are fixed to the mounting flanges 28a and 28b, respectively. Specifically, the first caliper-side restriction portion 31 and the second caliper-side restriction portion 32 are fixed to the mounting flanges 28a and 28b by press-fitting respective half portions thereof on the outer side in the axial direction into fixing holes 33 formed in the intermediate portions in the radial direction of the mounting flanges 28a and 28b. Respective half portions on the inner side in the axial direction of the respective first caliper-side restriction portion 31 and second caliper-side restriction portion 32 protrude in the axial direction from the inner surfaces in the axial direction of the mounting flanges 28a and 28b, and have a convex shape. As a fixing method for fixing the caliper-side restriction portion to the caliper, other methods such as adhesion fixing and caulking fixing can be adopted in addition to press-fitting fixing.

The first caliper-side restriction portion 31 and the second caliper-side restriction portion 32 respectively have, on an outer peripheral surface of a portion protruding in the axial direction from the inner surface in the axial direction of the mounting flange 28a or 28b, one of caliper-side restriction surfaces 34a and 34b having a convex cylindrical surface shape (curved surface shape). Examples of the curved surface shape include a cylindrical surface shape, a spherical surface shape, and a paraboloid shape.

Since the first caliper-side restriction portion 31 and the second caliper-side restriction portion 32 are respectively fixed to the intermediate portions in the radial direction of the mounting flanges 28a and 28b, the first caliper-side restriction portion 31 and the second caliper-side restriction portion 32 are disposed non-coaxially with a first spindle 36a (described later) disposed coaxially with the first cylinder 18a in the first cylinder 18a and a second spindle 36b (described later) disposed coaxially with the second cylinder 18b in the second cylinder 18b.

In the present example, with reference to a position of the first caliper-side restriction portion 31, a circumferential position and a radial position of the second caliper-side restriction portion 32 are restricted, and a circumferential position and a radial position of the central axis of each of the first cylinder 18a and the second cylinder 18b are restricted.

The first caliper-side restriction portion 31 and the second caliper-side restriction portion 32 are disposed to be separated from each other in the circumferential direction. A central axis of the first caliper-side restriction portion 31 and a central axis of the second caliper-side restriction portion 32 are disposed parallel to each other.

A virtual line O_{A} orthogonal to the central axis of each of the first caliper-side restriction portion 31 and the second caliper-side restriction portion 32 is disposed parallel to a virtual line Ois orthogonal to the central axis of each of the first cylinder 18a and the second cylinder 18b.

The first caliper-side restriction portion 31 is disposed on the other side in the circumferential direction with respect to a virtual line connecting a central axis of the through hole 29a of the mounting flange 28a and the central axis of the first cylinder 18a, and the second caliper-side restriction portion 32 is disposed on one side in the circumferential direction with respect to a virtual line connecting a central axis of the through hole 29b of the mounting flange 28b and the central axis of the second cylinder 18b. However, the first caliper-side restriction portion 31 may be disposed on the virtual line connecting the central axis of the through hole 29a and the central axis of the first cylinder 18a or on one side in the circumferential direction with respect to the virtual line, and the second caliper-side restriction portion 32 may be disposed on the virtual line connecting the central axis of the through hole 29b and the central axis of the second cylinder 18b or on the other side in the circumferential direction with respect to the virtual line.

In the present example, the first caliper-side restriction portion 31 and the second caliper-side restriction portion 32 are formed separately from the caliper 2 and fixed to the caliper 2, but two or one caliper-side restriction portion may be formed integrally with the caliper.

<Piston>

The disc brake device 1 according to the present example includes two pistons of a first piston 3a and a second piston 3b. The first piston 3a is fitted into the first cylinder 18a. The second piston 3b is fitted into the second cylinder 18b. Each of the first piston 3a and the second piston 3b is made of carbon steel such as S10C or S45C, and is formed in a bottomed cylindrical shape.

Female splines 35a and 35b are provided on inner peripheral surfaces of the first piston 3a and the second piston 3b, respectively. End portions on the outer side in the axial direction of the first piston 3a and the second piston 3b are suppressed from rotating with respect to the back plate 17 of the inner pad 10b by a rotation-suppressing mechanism (not illustrated). A piston boot is extended across a portion between a portion on the outer side in the axial direction of an outer peripheral surface of the first piston 3a and an opening edge portion on the outer side in the axial direction of the first cylinder 18a, and a portion between a portion on the outer side in the axial direction of an outer peripheral surface of the second piston 3b and an opening edge portion on the outer side in the axial direction of the second cylinder 18b.

<Rotation-Linear Motion Conversion Mechanism>

The disc brake device 1 according to the present example includes two rotation-linear motion conversion mechanisms of a first rotation-linear motion conversion mechanism 4a and a second rotation-linear motion conversion mechanism 4b. Each of the first rotation-linear motion conversion mechanism 4a and the second rotation-linear motion conversion mechanism 4b is a feed screw mechanism that converts a rotational motion into a linear motion and changes a total length in the axial direction during operation.

The first rotation-linear motion conversion mechanism 4a is disposed in the first cylinder 18a and pushes out the first piston 3a toward the rotor 11. The first rotation-linear motion conversion mechanism 4a includes the first spindle 36a corresponding to a rotation member, a first nut 37a corresponding to a linear motion member, and a plurality of balls 38a. Each of the first spindle 36a and the first nut 37a is disposed coaxially with the first cylinder 18a.

The second rotation-linear motion conversion mechanism 4b is disposed in the second cylinder 18b and pushes out the second piston 3b toward the rotor 11. The second rotation-linear motion conversion mechanism 4b includes the second spindle 36b corresponding to a rotation member, a second nut 37b corresponding to a linear motion member, and a plurality of balls 38b. Each of the second spindle 36b and the second nut 37b is disposed coaxially with the second cylinder 18b. Therefore, the first spindle 36a and the second spindle 36b are disposed parallel to each other.

In the present example, since the circumferential position and the radial position of the central axis of each of the first cylinder 18a and the second cylinder 18b are restricted with reference to the position of the first caliper-side restriction portion 31, a circumferential position and a radial position of each of the first spindle 36a disposed coaxially with the first cylinder 18a and the second spindle 36b disposed coaxially with the second cylinder 18b are restricted with reference to the position of the first caliper-side restriction portion 31.

The first spindle 36a and the second spindle 36b respectively include large-diameter shafts 39a and 39b in half portions thereof on the outer side in the axial direction and include small-diameter shafts 40a and 40b in half portions thereof on the inner side in the axial direction. A spiral shaft-side screw groove is provided on an outer peripheral surface of each of the large-diameter shafts 39a and 39b. Intermediate portions in the axial direction of the small-diameter shafts 40a and 40b are respectively inserted into the insert-through holes 24a and 24b formed in the bottom portions 23a and 23b of the clamp base 19. Therefore, portions on the inner side in the axial direction of the respective small-diameter shafts 40a and 40b protrude toward the inner side in the axial direction from the clamp base 19. Male serrations 41a and 41b are formed on the outer peripheral surfaces of the portions on the inner side in the axial direction of the small-diameter shafts 40a and 40b, respectively.

Supporting rings 42a and 42b and thrust bearings 43a and 43b are fitted on the portions on the outer side in the axial direction of the small-diameter shafts 40a and 40b, respectively. The supporting rings 42a and 42b and the thrust bearings 43a and 43b are sandwiched in the axial direction between the large-diameter shafts 39a and 39b and the bottom portions 23a and 23b of the clamp base 19. As a result, a thrust load applied to the first spindle 36a and the second spindle 36b can be supported by the bottom portions 23a and 23b, and the first spindle 36a and the second spindle 36b can be rotated relative to the bottom portions 23a and 23b.

The first nut 37a and the second nut 37b have spiral nut-side screw grooves on inner peripheral surfaces thereof, and have male splines 44a and 44b on outer peripheral surfaces thereof, respectively.

The first nut 37a is disposed on the inner side of the first piston 3a, and the male spline 44a on the outer peripheral surface is spline-engaged with the female spline 35a provided in the first piston 3a. As a result, the first nut 37a is engaged with the first piston 3a so as to be relatively displaceable and non-rotatable in the axial direction. In addition, the second nut 37b is disposed on the inner side of the second piston 3b, and the male spline 44b on the outer peripheral surface is spline-engaged with the female spline 35b provided in the second piston 3b. As a result, the second nut 37b is engaged with the second piston 3b so as to be relatively displaceable and non-rotatable in the axial direction.

The balls 38a and 38b are disposed so as to be able to roll on an inner side of a spiral load path formed between the shaft-side screw groove and the nut-side screw groove. A start point and an end point of the load path are connected by a circulation path.

The first rotation-linear motion conversion mechanism 4a and the second rotation-linear motion conversion mechanism 4b respectively move the first nut 37a and the second nut 37b in the axial direction by rotationally driving the first spindle 36a and the second spindle 36b. Specifically, when the first spindle 36a and the second spindle 36b are rotationally driven in a forward rotation direction, the first nut 37a and the second nut 37b are moved in a direction approaching the rotor 11 (outer side in the axial direction). On the other hand, when the first spindle 36a and the second spindle 36b are rotationally driven in a reverse rotation direction, the first nut 37a and the second nut 37b are moved in a direction away from the rotor 11 (inner side in the axial direction). In addition, as the first rotation-linear motion conversion mechanism 4a and the second rotation-linear motion conversion mechanism 4b, a sliding feed screw device in which balls are omitted may be used.

<Motor Gear Unit>

The motor gear unit (MGU, electric drive device) 5 is a unit for electrically driving the first rotation-linear motion conversion mechanism 4a and the second rotation-linear motion conversion mechanism 4b, and includes an electric motor 45, a deceleration mechanism 46 including a first output shaft 51a and a second output shaft 51b, a non-excited operation brake 47, and the housing 48.

<<Electric Motor>>

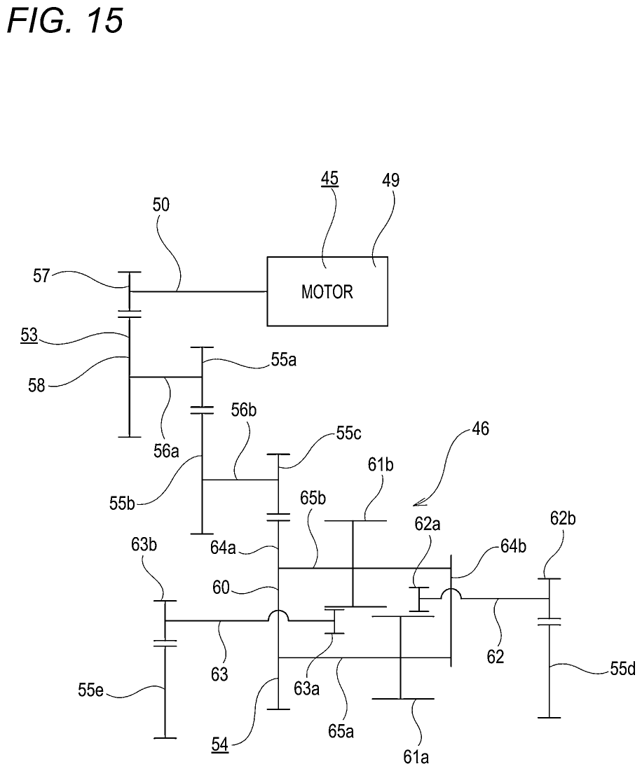

The electric motor 45 includes a motor main body 49 and a motor shaft 50. In FIG. 15, the motor main body 49 and the motor shaft 50 which are components of the electric motor 45 are schematically illustrated.

End portions on both sides in the axial direction of the motor shaft 50 protrude from the motor main body 49 to both sides in the axial direction. The deceleration mechanism 46 is connected to the end portion on one side in the axial direction of the motor shaft 50. On the other hand, the non-excited operation brake 47 is connected to the end portion on the other side in the axial direction of the motor shaft 50.

<<Deceleration Mechanism>>

The deceleration mechanism 46 increases a torque (power) of the electric motor 45 and transmits the increased torque to the first rotation-linear motion conversion mechanism 4a and the second rotation-linear motion conversion mechanism 4b.

In order to transmit rotation of the electric motor 45 to the first spindle 36a and the second spindle 36b, the deceleration mechanism 46 includes the output shafts 51a and 51b that have the same number as the spindles 36a and 36b and correspond to output members. The output member is not particularly limited as long as it is a member connectable to the rotation member and rotatable around its own central axis, and an output shaft, an output gear, an output pulley, or the like can be adopted.

In the present example, two output shafts of the first output shaft 51a and the second output shaft 51b are provided. The first output shaft 51a is disposed coaxially with the first spindle 36a, and is rotatably supported on an inner side of the housing 48. The second output shaft 51b is disposed coaxially with the second spindle 36b, and is rotatably supported on the inner side of the housing 48.

The first output shaft 51a and the second output shaft 51b respectively have serration holes 52a and 52b on end portions thereof on the outer side in the axial direction. The serration holes 52a and 52b are open in end surfaces on the outer side in the axial direction of the first output shaft 51a and the second output shaft 51b, respectively.

An end portion on the inner side in the axial direction of the first spindle 36a is inserted into the serration hole 52a of the first output shaft 51a. As a result, the serration hole 52a and the male serration 41a provided on the first spindle 36a are serration-engaged with each other, and the first output shaft 51a and the first spindle 36a are connected to each other in a relatively non-rotatable manner. In addition, an end portion on the inner side in the axial direction of the second spindle 36b is inserted into the serration hole 52b of the second output shaft 51b. As a result, the serration hole 52b and the male serration 41b provided on the second spindle 36b are serration-engaged with each other, and the second output shaft 51b and the second spindle 36b are connected to each other in a relatively non-rotatable manner.

The deceleration mechanism 46 according to the present example further includes a worm deceleration mechanism 53, a power distribution mechanism (differential) 54, a plurality of gears (spur gears) 55a to 55e, and a plurality of transmission shafts 56a and 56b. The plurality of transmission shafts 56a and 56b are rotatably supported on the inner side of the housing 48. In FIG. 15, some of the worm deceleration mechanism 53, the power distribution mechanism 54, the plurality of gears 55a to 55e, and the transmission shafts 56a and 56b, which are components of the deceleration mechanism 46, are schematically illustrated.

The worm deceleration mechanism 53 is connected to an end portion on one side in the axial direction of the motor shaft 50. The worm deceleration mechanism 53 includes a worm 57 and a worm wheel 58, and does not have a self-lock function.

The worm 57 is disposed coaxially with the motor shaft 50, and is connected to the end portion on one side in the axial direction of the motor shaft 50 in a relatively non-rotatable manner.

The worm wheel 58 is fixed so as not to be rotatable relative to the transmission shaft 56a, and meshes with the worm 57.

A first gear 55a is externally fitted and fixed to the transmission shaft 56a in a relatively non-rotatable manner at a portion deviated from the worm wheel 58 in the axial direction. The first gear 55a meshes with a second gear 55b that is externally fitted and fixed so as not to be rotatable relative to the transmission shaft 56b. A third gear 55c having a smaller number of teeth than the second gear 55b is externally fitted and fixed to the transmission shaft 56b in a relatively non-rotatable manner at a portion deviated from the second gear 55b in the axial direction. The third gear 55c meshes with an input element 60 constituting the power distribution mechanism 54.

A fourth gear 55d as a final gear is externally fitted and fixed to the first output shaft 51a, and a fifth gear 55e as a final gear is externally fitted and fixed to the second output shaft 51b. The fourth gear 55d meshes with a first output element 62 (described later) constituting the power distribution mechanism 54, and the fifth gear 55e meshes with a second output element 63 (described later) constituting the power distribution mechanism 54.

The power distribution mechanism 54 includes a support shaft 59, the input element 60, intermediate gears 61a and 61b, the first output element 62, and the second output element 63. The input element 60, the first output element 62, and the second output element 63 are also gears having tooth portions on outer peripheral surfaces thereof.

The input element 60 includes a pair of support rings 64a and 64b each having a circular ring shape, and a plurality of pins 65a and 65b extending between the support rings 64a and 64b. A tooth portion that meshes with the third gear 55c is provided on an outer peripheral surface of one support ring 64a. The second output element 63 is inserted into an inner side of the one support ring 64a. The first output element 62 is inserted into an inner side of the other support ring 64b. The pins 65a and 65b are disposed parallel to the support shaft 59.

The intermediate gears 61a and 61b are rotatably supported with respect to the input element 60. Specifically, the intermediate gears 61a and 61b are rotatably supported around the pins 65a and 65b, and are disposed on a portion between the pair of support rings 64a and 64b. The intermediate gear 61a and the intermediate gear 61b mesh with each other.

The first output element 62 is formed in a hollow cylindrical shape and is rotatably supported around the support shaft 59. The first output element 62 includes an input tooth portion 62a and an output tooth portion 62b. The input tooth portion 62a meshes with one intermediate gear 61a. On the other hand, the output tooth portion 62b meshes with the fourth gear 55d that is externally fitted and fixed to the first output shaft 51a in a relatively non-rotatable manner and that is a final gear.

The second output element 63 is formed in a hollow cylindrical shape and is rotatably supported around the support shaft 59. The second output element 63 includes an input tooth portion 63a and an output tooth portion 63b. The input tooth portion 63a meshes with the other intermediate gear 61b. On the other hand, the output tooth portion 63b meshes with the fifth gear 55e that is externally fitted and fixed to the second output shaft 51b in a relatively non-rotatable manner and that is a final gear.

Therefore, rotation of the first output element 62 is transmitted to the first output shaft 51a through a meshing portion between the output tooth portion 62b and the fourth gear 55d which is a final gear. In addition, rotation of the second output element 63 is transmitted to the second output shaft 51b through a meshing portion between the output tooth portion 63b and the fifth gear 55e which is a final gear.

The power distribution mechanism 54 has a function of distributing and transmitting power input to the input element 60 to the fourth gear 55d which is a final gear fixed to the first output shaft 51a in a relatively non-rotatable manner and the fifth gear 55e which is a final gear fixed to the second output shaft 51b in a relatively non-rotatable manner. Specifically, power corresponding to a magnitude of a rotation load (ease of rotation) of the first spindle 36a and the second spindle 36b is distributed to the fourth gear 55d and the fifth gear 55e. As a result, regardless of a difference in efficiency between the first rotation-linear motion conversion mechanism 4a and the second rotation-linear motion conversion mechanism 4b, a difference is suppressed from occurring between a force with which the first piston 3a presses the inner pad 10b by the first rotation-linear motion conversion mechanism 4a and a force with which the second piston 3b presses the inner pad 10b by the second rotation-linear motion conversion mechanism 4b.

<<Non-Excited Operation Brake>>

The non-excited operation brake 47 is connected to the end portion on the other side in the axial direction of the motor shaft 50. The non-excited operation brake 47 is a friction brake, and has a function of allowing the rotation of the motor shaft 50 when being energized and suppressing the rotation of the motor shaft 50 when not being energized.

<<Housing>>

The housing 48 is made of synthetic resin or metal, and accommodates the electric motor 45, the deceleration mechanism 46, and the non-excited operation brake 47.

The housing 48 is fixed on the inner side in the axial direction of the clamp base 19 constituting the caliper 2. Therefore, the housing 48 has a caliper facing surface 66 on an outer surface in the axial direction.

The caliper facing surface 66 has insertion holes 67a and 67b in portions facing respective end surfaces on the outer side in the axial direction of the first output shaft 51a and the second output shaft 51b.

The caliper facing surface 66 has, around the insertion holes 67a and 67b, annular concave portions 68a and 68b which are disposed coaxially with respective central axes of the insertion holes 67a and 67b and are slightly recessed toward the inner side in the axial direction. A bottom surface of the annular concave portion 68a has a circular ring shape and is a flat surface existing on a virtual plane orthogonal to a central axis of the first output shaft 51a. A bottom surface of the annular concave portion 68b has a circular ring shape and is a flat surface existing on a virtual plane orthogonal to a central axis of the second output shaft 51b.

The caliper facing surface 66 includes a reinforcing rib 69 in a portion located on the outer side in the radial direction of the annular concave portions 68a and 68b and a portion located between the annular concave portions 68a and 68b in the circumferential direction. In the present example, by providing the reinforcing rib 69 in the housing 48, both weight reduction and rigidity ensuring of the housing 48 can be achieved.

A portion located on the outer side in the radial direction with respect to the annular concave portions 68a and 68b within the reinforcing rib 69 has a lattice shape and includes a plurality of first reinforcing plates 70a and a plurality of second reinforcing plates 70b.

The plurality of first reinforcing plates 70a extend in the circumferential direction and are disposed in parallel to each other so as to be separated in the radial direction. The plurality of second reinforcing plates 70b extend in the radial direction and are disposed in parallel to each other so as to be separated in the circumferential direction. The second reinforcing plate 70b is disposed at a right angle to the first reinforcing plate 70a, and connects two first reinforcing plates 70a disposed to be separated in the radial direction.

An interval between the first reinforcing plates 70a adjacent to each other in the radial direction is sufficiently larger than diameters of the first caliper-side restriction portion 31 and the second caliper-side restriction portion 32. In addition, an interval between the second reinforcing plates 70b adjacent to each other in the circumferential direction is sufficiently larger than the diameters of the first caliper-side restriction portion 31 and the second caliper-side restriction portion 32.

The caliper facing surface 66 has two tubular portions 71a and 71b on end portions on both sides in the circumferential direction of the end portions on the outer side in the radial direction of the reinforcing rib 69. In addition, the caliper facing surface 66 has a tubular portion 71c in a portion on the inner side in the radial direction of a portion between the annular concave portions 68a and 68b in the circumferential direction. The tubular portions 71a to 71c project toward the outer side in the axial direction from the reinforcing rib 69. In the present example, in a state where the housing 48 is fixed to the caliper 2, except for a contacting portion between the first caliper-side restriction portion 31 and a first housing-side restriction portion 75 (described later) and a contacting portion between the second caliper-side restriction portion 32 and a second housing-side restriction portion 76 (described later), only the end surfaces on the outer side in the axial direction of the tubular portions 71a to 71c are brought into contact with the housing facing surface 25.

The two tubular portions 71a and 71b disposed on the outer side in the radial direction have female screw holes 72a and 72b in inner peripheral surfaces thereof, respectively. On the other hand, one tubular portion 71c disposed on the inner side in the radial direction has a penetration hole 73 on the inner side. The female screw holes 72a and 72b and the penetration hole 73 are open in the caliper facing surface 66.

The housing 48 is fixed to the inner side in the axial direction of the clamp base 19 of the caliper 2 by using the mounting bolts 74a to 74c each constituting the fixing portion 8. Specifically, the mounting bolts 74a and 74b inserted into the through holes 29a and 29b provided in the mounting flanges 28a and 28b of the caliper 2 from the outer side in the axial direction to the inner side in the axial direction are screwed into the female screw holes 72a and 72b of the housing 48, and the mounting bolt 74c inserted into the penetration hole 73 of the housing 48 from the inner side in the axial direction to the outer side in the axial direction is screwed into the female screw hole 30 provided in the mounting flange 28c of the caliper 2. As a result, the housing 48 is fixed to the inner side in the axial direction of the clamp base 19.

In the present example, the mounting bolts 74a and 74b are loosely inserted into the through holes 29a and 29b of the mounting flanges 28a and 28b, and the mounting bolt 74c is loosely inserted into the penetration hole 73 of the housing 48. Therefore, the mounting bolts 74a to 74c cannot strictly restrict the position of the housing 48 with respect to the caliper 2.

The housing 48 includes a plurality of housing-side restriction portions 75 and 76 constituting the position restriction portion 7 in order to restrict the position of the motor gear unit 5 with respect to the caliper 2. In the present example, the housing 48 includes two housing-side restriction portions of the first housing-side restriction portion 75 and the second housing-side restriction portion 76.

Each of the first housing-side restriction portion 75 and the second housing-side restriction portion 76 is integrally formed with the housing 48. Specifically, each of the first housing-side restriction portion 75 and the second housing-side restriction portion 76 is provided in a part of the reinforcing rib 69. Therefore, each of the first housing-side restriction portion 75 and the second housing-side restriction portion 76 is disposed non-coaxially with each of the first output shaft 51a and the second output shaft 51b.

The first housing-side restriction portion 75 is formed by the first reinforcing plate 70a disposed in a portion in the radial direction between the annular concave portion 68a and the tubular portion 71a that are disposed on one side in the circumferential direction, and the second reinforcing plate 70b in which the end portion on the outer side in the radial direction is connected to the end portion on one side in the circumferential direction of the first reinforcing plate 70a. Therefore, the first housing-side restriction portion 75 is formed in an L-shaped plate shape, has a housing-side restriction surface 77a having a flat surface shape on the inner surface in the radial direction, and has a housing-side restriction surface 77b having a flat surface shape on a side surface facing the other side in the circumferential direction. That is, the first housing-side restriction portion 75 has two housing-side restriction surfaces 77a and 77b having a flat surface shape. The two housing-side restriction surfaces 77a and 77b are connected to each other at a right angle.

On the other hand, the second housing-side restriction portion 76 is formed only by the first reinforcing plate 70a disposed in a portion in the radial direction between the annular concave portion 68b and the tubular portion 71b that are disposed on the other side in the circumferential direction. Therefore, the second housing-side restriction portion 76 is formed in a flat plate shape, and has a housing-side restriction surface 77c having a flat surface shape on the inner surface in the radial direction. That is, the second housing-side restriction portion 76 has one housing-side restriction surface 77c having a flat surface shape.

The housing-side restriction surface 77a of the first housing-side restriction portion 75 and the housing-side restriction surface 77c of the second housing-side restriction portion 76 exist on the same virtual plane, and are parallel to a virtual line O₅₁ orthogonal to each of the central axes of the first output shaft 51a and the second output shaft 51b.

In the present example, a circumferential position and a radial position of each of the first output shaft 51a and the second output shaft 51b rotatably supported on the inner side of the housing 48 are restricted with reference to a position of the first housing-side restriction portion 75, that is, a radial position of the housing-side restriction surface 77a and a circumferential position of the housing-side restriction surface 77b.

In the present example, in a state before the housing 48 is fixed to the caliper 2 by the fixing portion 8, the position of the housing 48 with respect to the caliper 2 is restricted using the position restriction portion 7.

Specifically, when the caliper facing surface 66 is superimposed on the housing facing surface 25, an end portion on the outer side in the radial direction of the caliper-side restriction surface 34a, which has a convex cylindrical surface shape, of the first caliper-side restriction portion 31 is brought into contact with the housing-side restriction surface 77a, which has a flat surface shape, of the first housing-side restriction portion 75, and an end portion on one side in the circumferential direction of the caliper-side restriction surface 34a, which has a convex cylindrical surface shape, of the first caliper-side restriction portion 31 is brought into contact with the housing-side restriction surface 77b, which has a flat surface shape, of the first housing-side restriction portion 75. As a result, a circumferential position and a radial position of each of the first caliper-side restriction portion 31 and the first housing-side restriction portion 75 are restricted. In other words, the circumferential position and the radial position of each of the first caliper-side restriction portion 31 and the first housing-side restriction portion 75 are matched. The first caliper-side restriction portion 31 and the first housing-side restriction portion 75 are used as reference points for position restriction.

Further, from a state where the first caliper-side restriction portion 31 and the first housing-side restriction portion 75 are brought into contact with each other, an end portion on the outer side in the radial direction of the caliper-side restriction surface 34b, which has a convex cylindrical surface shape, of the second caliper-side restriction portion 32 is brought into contact with the housing-side restriction surface 77c, which has a flat surface shape, of the second housing-side restriction portion 76. That is, in the present example, the caliper-side restriction surface 34b and the housing-side restriction surface 77c are brought into contact with each other in the radial direction. As a result, a relative rotation position (rotation phase) between the caliper 2 and the housing 48 around a central axis O₃₁ of the first caliper-side restriction portion 31 serving as a reference point is restricted. In the present example, the position of the housing 48 with respect to the caliper 2 is restricted in this manner.

In the present example, the caliper facing surface 66 is superposed on the housing facing surface 25 in a state where an orientation of the housing 48 is restricted such that a portion on the inner side in the radial direction of the housing 48 faces a lower side in the vertical direction. As a result, the first caliper-side restriction portion 31 and the first housing-side restriction portion 75 can be brought into contact with each other and the second caliper-side restriction portion 32 and the second housing-side restriction portion 76 can be brought into contact with each other by utilizing gravity applied to the housing 48. The housing 48 is fixed to the caliper 2 by the fixing portion 8 in a state where the first caliper-side restriction portion 31 and the first housing-side restriction portion 75 are brought into contact with each other and the second caliper-side restriction portion 32 and the second housing-side restriction portion 76 are brought into contact with each other by the action of gravity.

Alternatively, by utilizing a rotational force (moment force) applied to the housing 48 from the mounting bolts 74a and 74b when tightening the mounting bolts 74a and 74b, or a rotational force applied to the caliper 2 from the mounting bolt 74c when tightening the mounting bolt 74c, the first caliper-side restriction portion 31 and the first housing-side restriction portion 75 can be brought into contact with each other and the second caliper-side restriction portion 32 and the second housing-side restriction portion 76 can be brought into contact with each other.

In the present example, in order to perform sealing between the caliper 2 and the housing 48, a first annular seal 6a and a second annular seal 6b are disposed between the housing facing surface 25 and the caliper facing surface 66.

In the present example, the first annular seal 6a is disposed coaxially with the first spindle 36a, and elastically sandwiched in the axial direction between the circular ring surface 27a of the housing facing surface 25 and the bottom surface of the annular concave portion 68a of the caliper facing surface 66. In addition, the second annular seal 6b is disposed coaxially with the second spindle 36b, and elastically sandwiched in the axial direction between the circular ring surface 27b of the housing facing surface 25 and the bottom surface of the annular concave portion 68b of the caliper facing surface 66. As a result, sealing is performed between the caliper 2 and the housing 48.

[Description of Operation of Disc Brake Device]

When the service brake is caused to operate by the disc brake device 1 according to the present example, brake oil is fed to the first cylinder 18a and the second cylinder 18b through an oil passage (not illustrated). As a result, the first piston 3a and the second piston 3b are pushed out from the first cylinder 18a and the second cylinder 18b, and the inner pad 10b is pressed against an inner surface in the axial direction of the rotor 11. In addition, the caliper 2 is displaced to the inner side in the axial direction with respect to the support 9 by a reaction force caused by the pressing. Further, the outer pad 10a is pressed against an outer surface in the axial direction of the rotor 11 by the pressing portion 20 of the caliper 2. As a result, a braking force is obtained by friction applied to contact surfaces of the outer pad 10a and the inner pad 10b with the rotor 11. In this way, the disc brake device 1 obtains the braking force caused by the service brake by pushing out the first piston 3a and the second piston 3b by introducing the brake oil.

When the parking brake is caused to operate by the disc brake device 1, the electric motor 45 constituting the motor gear unit 5 is energized, and the first spindle 36a and the second spindle 36b are rotationally driven in the forward rotation direction via the deceleration mechanism 46. As a result, the first nut 37a and the second nut 37b are moved toward the outer side in the axial direction. By pushing out the first piston 3a and the second piston 3b toward the rotor 11, the inner pad 10b is pressed against the inner surface in the axial direction of the rotor 11. In addition, the caliper 2 is displaced to the inner side in the axial direction with respect to the support 9 by a reaction force caused by the pressing. Further, the outer pad 10a is pressed against an outer surface in the axial direction of the rotor 11 by the pressing portion 20 of the caliper 2. As a result, a braking force is obtained by friction applied to contact surfaces of the inner pad 10b and the outer pad 10a with the rotor 11. In this way, the disc brake device 1 obtains the braking force caused by the parking brake by pushing out the first piston 3a and the second piston 3b using the motor gear unit 5.

In a non-energization state where an engine of an automobile is stopped and energization to the electric motor 45 is stopped, energization to an electromagnetic coil constituting the non-excited operation brake 47 is stopped. Therefore, rotation of the motor shaft 50 can be suppressed by the non-excited operation brake 47. Therefore, the disc brake device 1 according to the present example can maintain the braking force caused by the parking brake even in a state where energization to the electric motor 45 is stopped.

According to the disc brake device 1 of the present example, each of coaxiality between the first spindle 36a and the first output shaft 51a and coaxiality between the second spindle 36b and the second output shaft 51b can be ensured, and sealing performance between the caliper 2 and the housing 48 can be ensured.

That is, in the present example, in a state before the housing 48 is fixed to the caliper 2, the circumferential position and the radial position of each of the first caliper-side restriction portion 31 and the first housing-side restriction portion 75 are restricted by bringing the first caliper-side restriction portion 31 and the first housing-side restriction portion 75 into contact with each other. That is, the circumferential positions and the radial positions of the first caliper-side restriction portion 31 and the first housing-side restriction portion 75 are matched, respectively. Further, from this state, the relative rotation position between the caliper 2 and the housing 48 about the central axis O₃₁ of the first caliper-side restriction portion 31 serving as a reference point is restricted by bringing the second caliper-side restriction portion 32 and the second housing-side restriction portion 76 into contact with each other. As a result, in the present example, the position (circumferential position, radial position, and relative rotation position) of the housing 48 with respect to the caliper 2 can be strictly restricted.

In addition, in the present example, a position (circumferential position and radial position) of the central axis of each of the first spindle 36a and the second spindle 36b is restricted with reference to the position of the first caliper-side restriction portion 31, and a position (circumferential position and radial position) of the central axis of each of the first output shaft 51a and the second output shaft 51b is restricted with reference to the position of the first housing-side restriction portion 75.

Therefore, according to the disc brake device 1 of the present example, each of the coaxiality between the first spindle 36a and the first output shaft 51a and the coaxiality between the second spindle 36b and the second output shaft 51b can be ensured. Therefore, it is possible to suppress a decrease in conversion efficiency of the first rotation-linear motion conversion mechanism 4a and the second rotation-linear motion conversion mechanism 4b. In addition, abnormal wear of each sliding portion can be suppressed. Further, leakage of the brake oil can be suppressed.

In the present example, the first annular seal 6a is disposed coaxially with the first spindle 36a, and elastically sandwiched in the axial direction between the circular ring surface 27a of the housing facing surface 25 and the bottom surface of the annular concave portion 68a of the caliper facing surface 66. In addition, the second annular seal 6b is disposed coaxially with the second spindle 36b, and elastically sandwiched in the axial direction between the circular ring surface 27b of the housing facing surface 25 and the bottom surface of the annular concave portion 68b of the caliper facing surface 66. Therefore, sealing can be performed between the caliper 2 and the housing 48 by the first annular seal 6a and the second annular seal 6b. Specifically, it is possible to suppress foreign matter from entering the inner side of the first cylinder 18a and the second cylinder 18b through the insert-through holes 24a and 24b open in the housing facing surface 25, and to suppress foreign matter from entering the inner side of the housing 48 through the insertion holes 67a and 67 open in the caliper facing surface 66. In particular, in the present example, the first annular seal 6a is sandwiched in the axial direction between the circular ring surface 27a and the bottom surface of the annular concave portion 68a, and is not disposed in a spigot-fitting portion. In addition, the second annular seal 6b is sandwiched in the axial direction between the circular ring surface 27b and the bottom surface of the annular concave portion 68b, and is not disposed in the spigot-fitting portion. Therefore, by ensuring a flatness of each of the circular ring surface 27a and the bottom surface of the annular concave portion 68a that sandwich the first annular seal 6a, and the circular ring surface 27b and the bottom surface of the annular concave portion 68b that sandwich the second annular seal 6b, separately from the matter that the coaxiality between the first spindle 36a and the first output shaft 51a and the coaxiality between the second spindle 36b and the second output shaft 51b are ensured, interference of each of the first annular seal 6a and the second annular seal 6b can be made uniform over the entire circumference, and a degree of freedom in design can be improved.

In the present example, since a part of the reinforcing rib 69 provided in the housing 48 is used as the first housing-side restriction portion 75 and the second housing-side restriction portion 76, an increase in the number of components can be suppressed, and weight reduction of the disc brake device 1 can be achieved.

In the present example, the respective half portions on the inner side in the axial direction of the first caliper-side restriction portion 31 and the second caliper-side restriction portion 32 are inserted and disposed in an inner side of a recessed portion 79 existing between the reinforcing ribs 69 provided on the caliper facing surface 66. Therefore, it is possible to suppress an increase in an axial dimension of the disc brake device 1 due to provision of the position restriction portion 7.

The first caliper-side restriction portion 31 and the second caliper-side restriction portion 32 respectively have the caliper-side restriction surfaces 34a and 34b having a cylindrical surface shape. Therefore, there is no need to limit a phase when the first caliper-side restriction portion 31 and the second caliper-side restriction portion 32 are inserted into the fixing hole 33, and the assembly cost can be reduced.

In the present example, by utilizing gravity applied to the housing 48, the first caliper-side restriction portion 31 and the first housing-side restriction portion 75 can be brought into contact with each other and the second caliper-side restriction portion 32 and the second housing-side restriction portion 76 can be brought into contact with each other, and thus a contact failure can be suppressed and the number of assembly steps can be reduced. In addition, by utilizing the rotational force when tightening the mounting bolts 74a to 74c, the first caliper-side restriction portion 31 and the first housing-side restriction portion 75 can be brought into contact with each other or/and the second caliper-side restriction portion 32 and the second housing-side restriction portion 76 can be brought into contact with each other. Also in this case, the number of assembly steps can be reduced.

### Second Example of Embodiment

A second example of the embodiment will be described with reference to FIG. 17.

In the present example, a step surface 80 is provided on an inner peripheral surface of a fixing hole 33a by changing an inner diameter of the fixing hole 33a formed in the caliper 2 stepwise. The end surface at the outer side in the axial direction of the first caliper-side restriction portion 31 (and the second caliper-side restriction portion 32) abuts against the step surface 80. It is also possible to adopt a configuration in which the fixing hole is a blind hole and the end surface of the caliper-side restriction portion abuts against a bottom surface of the fixing hole.

In addition, the end surface at the inner side in the axial direction of the first caliper-side restriction portion 31 (and the second caliper-side restriction portion 32) is made to face a bottom surface 79a of the recessed portion 79 provided in a portion between the reinforcing ribs 69 having an oblique lattice shape within the caliper facing surface 66.

As described above, in the present example, the first caliper-side restriction portion 31 (and the second caliper-side restriction portion 32) is sandwiched between the step surface 80 and the bottom surface 79a of the recessed portion 79 from both sides in the axial direction.

In the present example as described above, it is possible to effectively suppress the first caliper-side restriction portion 31 (and the second caliper-side restriction portion 32) from coming off from the fixing hole 33a in the axial direction by the step surface 80 and the bottom surface 79a of the recessed portion 79.

Other configurations, operations, and effects are the same as those of the first example of the embodiment.

### Third Example of Embodiment

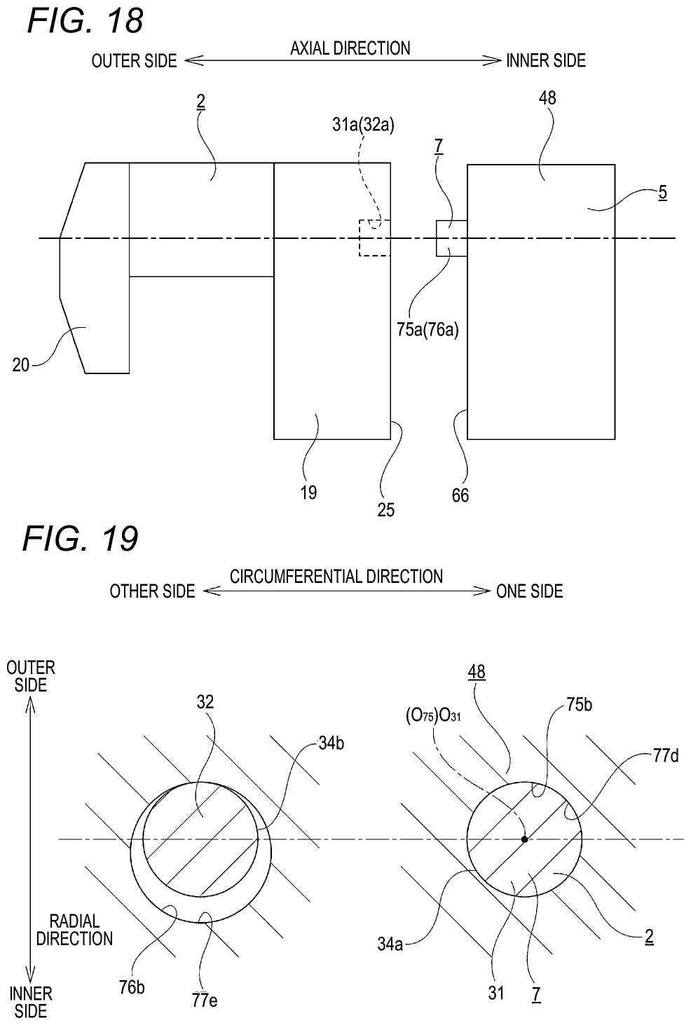

A third example of the embodiment will be described with reference to FIG. 18.

In the present example, only a structure of the position restriction portion 7 is changed from a structure thereof in the first example of the embodiment. Specifically, each of a first caliper-side restriction portion 31a and a second caliper-side restriction portion 32a provided on the housing facing surface 25 has a concave shape recessed in the axial direction, and each of a first housing-side restriction portion 75a and a second housing-side restriction portion 76a provided on the caliper facing surface 66 has a convex shape protruding in the axial direction.

In the present example, each of the first caliper-side restriction portion 31a and the second caliper-side restriction portion 32a is directly formed with respect to the caliper 2. On the other hand, each of the first housing-side restriction portion 75a and the second housing-side restriction portion 76a is formed separately from the housing 48 and is formed of a pin member molded and fixed to the housing 48, or is integrally formed with the housing 48.

In the present example as described above, since the first housing-side restriction portion 75a and the second housing-side restriction portion 76a are pin members molded and fixed to the housing 48, or are integrally formed with the housing 48, cost reduction of the disc brake device 1 can be achieved.

Other configurations, operations, and effects are the same as those of the first example of the embodiment.

### Fourth Example of Embodiment

A fourth example of the embodiment will be described with reference to FIG. 19.

In the present example, only a structure of the position restriction portion 7 is changed from a structure thereof in the first example of the embodiment. Specifically, only structures of a first housing-side restriction portion 75b and a second housing-side restriction portion 76b constituting the position restriction portion 7 are changed from structures thereof in the first example of the embodiment. Structures of the first caliper-side restriction portion 31 and the second caliper-side restriction portion 32 are the same as structures in the first example of the embodiment.

In the present example, each of the first housing-side restriction portion 75b and the second housing-side restriction portion 76b is a columnar concave portion having a concave shape recessed in the axial direction from the caliper facing surface 66. An inner diameter of the first housing-side restriction portion 75b is slightly larger than an outer diameter of the first caliper-side restriction portion 31, and an inner diameter of the second housing-side restriction portion 76b is sufficiently larger than an outer diameter of the second caliper-side restriction portion 32.

In the present example, by inserting without rattling, that is, lightly press-fitting the first caliper-side restriction portion 31 into the first housing-side restriction portion 75b, a housing-side restriction surface 77d having a concave cylindrical surface shape (curved surface shape) provided on the inner peripheral surface of the first housing-side restriction portion 75b is brought into contact with the caliper-side restriction surface 34a having a convex cylindrical surface shape provided on the outer peripheral surface of the first caliper-side restriction portion 31 over the entire circumference. As a result, a circumferential position and a radial position of each of the first caliper-side restriction portion 31 and the first housing-side restriction portion 75b are restricted. In the present example, since the caliper-side restriction surface 34a and the housing-side restriction surface 77d are brought into contact with each other over the entire circumference, the caliper 2 and the housing 48 are suppressed from moving in parallel in all directions other than rotation about the central axis O₃₁ of the first caliper-side restriction portion 31 (or a central axis O₇₅ of the first housing-side restriction portion 75b).

Further, in the present example, the end portion on the outer side in the radial direction within the caliper-side restriction surface 34b provided on the outer peripheral surface of the second caliper-side restriction portion 32 is brought into contact with an end portion on the outer side in the radial direction of a housing-side restriction surface 77e having a concave cylindrical surface shape provided on an inner peripheral surface of the second housing-side restriction portion 76b. That is, the housing-side restriction surface 77e and the caliper-side restriction surface 34b are brought into contact with each other in the radial direction. As a result, the relative rotation position between the caliper 2 and the housing 48 about the central axis O₃₁ of the first caliper-side restriction portion 31 (or the central axis O₇₅ of the first housing-side restriction portion 75b) serving as the reference point is restricted. The housing-side restriction surface 77e and the caliper-side restriction surface 34b can be brought into contact with each other by utilizing gravity applied to the housing 48. In addition, in a case where a configuration in which the end portion on the inner side in the radial direction within the caliper-side restriction surface 34b is brought into contact with an end portion on the inner side in the radial direction of the housing-side restriction surface 77e is adopted, the housing-side restriction surface 77e and the caliper-side restriction surface 34b can be brought into contact with each other by utilizing gravity applied to the caliper 2.

In the present example as described above, since the circumferential position and the radial position of each of the first caliper-side restriction portion 31 and the first housing-side restriction portion 75b can be restricted only by inserting the first caliper-side restriction portion 31 into the inner side of the first housing-side restriction portion 75b, workability of an assembly work can be improved, and the number of assembly steps can be reduced.

Other configurations, operations, and effects are the same as those of the first example of the embodiment.

### Fifth Example of Embodiment

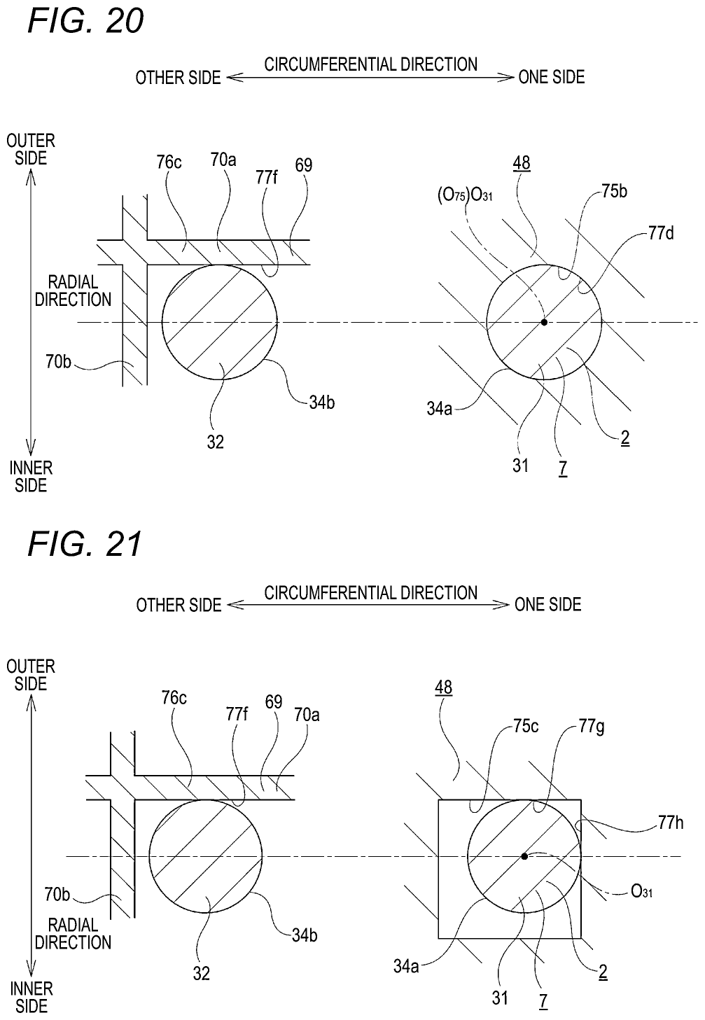

A fifth example of the embodiment will be described with reference to FIG. 20.

In the present example, only a structure of a second housing-side restriction portion 76c is changed from a structure thereof in the fourth example of the embodiment. The structures of the first caliper-side restriction portion 31, the second caliper-side restriction portion 32, and the first housing-side restriction portion 75b are the same as structures thereof in the fourth example of the embodiment.

In the present example, the first reinforcing plate 70a constituting the reinforcing rib 69 is used as the second housing-side restriction portion 76c. The end portion on the outer side in the radial direction within the caliper-side restriction surface 34b on the outer peripheral surface of the second caliper-side restriction portion 32 is brought into contact with a housing-side restriction surface 77f having a flat surface shape provided on the second housing-side restriction portion 76c. As a result, the relative rotation position between the caliper 2 and the housing 48 about the central axis O₃₁ of the first caliper-side restriction portion 31 (or the central axis O₇₅ of the first housing-side restriction portion 75b) serving as the reference point is restricted. Also in the case of the present example, the housing-side restriction surface 77f and the caliper-side restriction surface 34b can be brought into contact with each other by utilizing gravity applied to the housing 48.

In the present example as described above, since a part of the reinforcing rib 69 can be used as the second housing-side restriction portion 76c, cost can be reduced.

Other configurations, operations, and effects are the same as those of the first example and the fourth example of the embodiment.

### Sixth Example of Embodiment

A sixth example of the embodiment will be described with reference to FIG. 21.

In the present example, only a structure of a first housing-side restriction portion 75c is changed from a structure thereof in the fifth example of the embodiment. The structures of the first caliper-side restriction portion 31, the second caliper-side restriction portion 32, and the second housing-side restriction portion 76c are the same as structures thereof in the fifth example of the embodiment.

In the present example, the first housing-side restriction portion 75c is a quadrangular concave portion or a quadrangular hole having a concave shape recessed in the axial direction from the caliper facing surface 66. The first housing-side restriction portion 75c has two housing-side restriction surfaces 77g and 77h each having a flat surface shape on an inner peripheral surface thereof. The two housing-side restriction surfaces 77g and 77h are connected to each other at a right angle.

In the present example, the end portion on the outer side in the radial direction of the caliper-side restriction surface 34a having a convex cylindrical surface shape of the first caliper-side restriction portion 31 is brought into contact with the housing-side restriction surface 77g having a flat surface shape of the first housing-side restriction portion 75c, and the end portion on the one side in the circumferential direction of the caliper-side restriction surface 34a having a convex cylindrical surface shape of the first caliper-side restriction portion 31 is brought into contact with the housing-side restriction surface 77h having a flat surface shape of the first housing-side restriction portion 75c. As a result, a circumferential position and a radial position of each of the first caliper-side restriction portion 31 and the first housing-side restriction portion 75c are restricted.

In the case of the present example as described above, since the first housing-side restriction portion 75c is a quadrangular concave portion or a quadrangular hole, the first housing-side restriction portion 75c can be more easily formed by injection molding or press working. Accordingly, machining cost of the first housing-side restriction portion 75c can be reduced.

Other configurations, operations, and effects are the same as those of the first example and the fifth example of the embodiment.

### Seventh Example of Embodiment

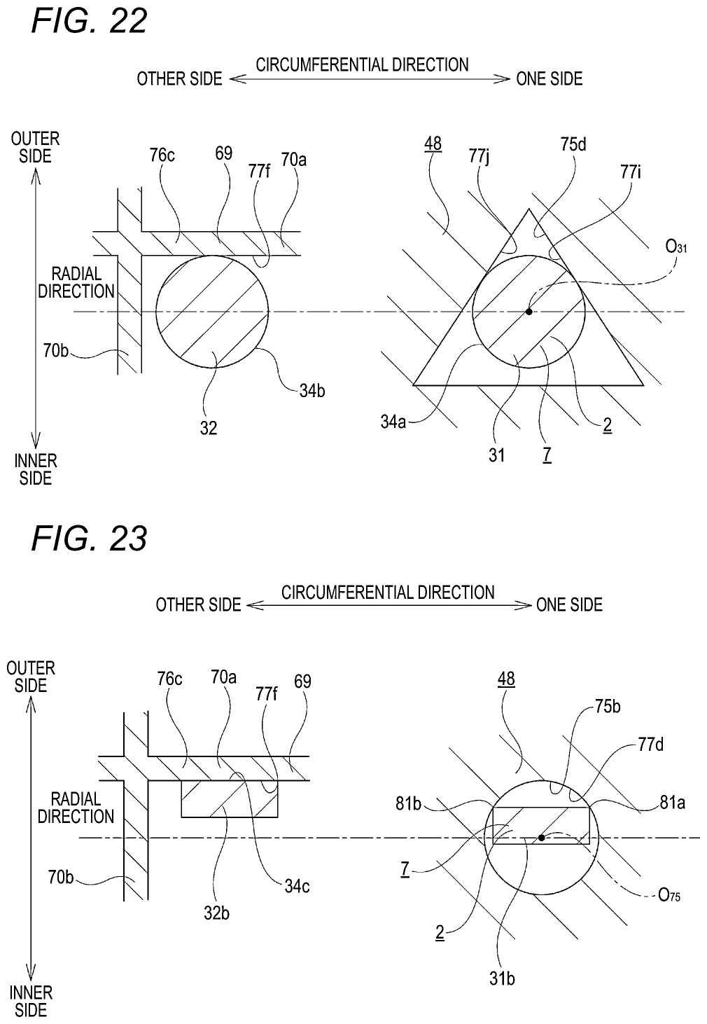

A seventh example of the embodiment will be described with reference to FIG. 22.

Also in the case of the present example, only a structure of a first housing-side restriction portion 75d is changed from a structure thereof in the fifth example of the embodiment. The structures of the first caliper-side restriction portion 31, the second caliper-side restriction portion 32, and the second housing-side restriction portion 76c are the same as structures thereof in the fifth example of the embodiment.

In the present example, the first housing-side restriction portion 75d is a triangular concave portion or a triangular hole having a concave shape recessed in the axial direction from the caliper facing surface 66. The first housing-side restriction portion 75d has two housing-side restriction surfaces 77i and 77j each having a flat surface shape on an inner peripheral surface thereof. The two housing-side restriction surfaces 77i and 77j are connected to each other such that an included angle is an acute angle.

In the present example, the caliper-side restriction surface 34a having a convex cylindrical surface shape of the first caliper-side restriction portion 31 is brought into contact with the two housing-side restriction surfaces 77i and 77j having a flat surface shape of the first housing-side restriction portion 75d. As a result, a circumferential position and a radial position of each of the first caliper-side restriction portion 31 and the first housing-side restriction portion 75d are restricted.

In the present example as described above, the housing 48 can be suppressed from moving in the circumferential direction relative to the caliper 2 in a state where the first caliper-side restriction portion 31 is inserted into an inner side of the first housing-side restriction portion 75d and the caliper-side restriction surface 34a is brought into contact with the two housing-side restriction surfaces 77i and 77j at the same time. Therefore, the workability of the assembly work can be improved, and the number of assembly steps can be reduced.

Other configurations, operations, and effects are the same as those of the first example and the fifth example of the embodiment.

### Eighth Example of Embodiment

An eighth example of the embodiment will be described with reference to FIG. 23.

Also in the case of the present example, only structures of the first caliper-side restriction portion 31b and the second caliper-side restriction portion 32b are changed from structures thereof in the fifth example of the embodiment. Structures of the first housing-side restriction portion 75b and the second housing-side restriction portion 76c are the same as structures thereof in the fifth example of the embodiment.

In the present example, each of the first caliper-side restriction portion 31b and the second caliper-side restriction portion 32b is a quadrangular prism having a convex shape protruding in the axial direction from the housing facing surface 25. The first caliper-side restriction portion 31b includes a caliper-side restriction corner portion 81a that connects an outer surface in the radial direction and a side surface on one side in the circumferential direction, and a caliper-side restriction corner portion 81b that connects the outer surface in the radial direction and a side surface on the other side in the circumferential direction. On the other hand, the second caliper-side restriction portion 32b has a caliper-side restriction surface 34c having a flat surface shape on the outer surface in the radial direction.

In the present example, by inserting the first caliper-side restriction portion 31b into the first housing-side restriction portion 75b, the two caliper-side restriction corner portions 81a and 81b provided in the first caliper-side restriction portion 31b are brought into contact with the housing-side restriction surface 77d having a concave cylindrical surface shape provided on the inner peripheral surface of the first housing-side restriction portion 75b. As a result, a circumferential position and a radial position of each of the first caliper-side restriction portion 31b and the first housing-side restriction portion 75b are restricted.

Further, in the present example, the caliper-side restriction surface 34c provided in the second caliper-side restriction portion 32b is brought into surface contact with the housing-side restriction surface 77f having a flat surface shape provided in the second housing-side restriction portion 76c. As a result, the relative rotation position between the caliper 2 and the housing 48 around the central axis O₇₅ of the first housing-side restriction portion 75b serving as a reference point is restricted.

In the present example as described above, since the caliper-side restriction surface 34c and the housing-side restriction surface 77f are brought into surface contact with each other, the relative rotation position between the caliper 2 and the housing 48 can be strictly restricted.

Other configurations, operations, and effects are the same as those of the first example and the fifth example of the embodiment.

### Ninth Example of Embodiment

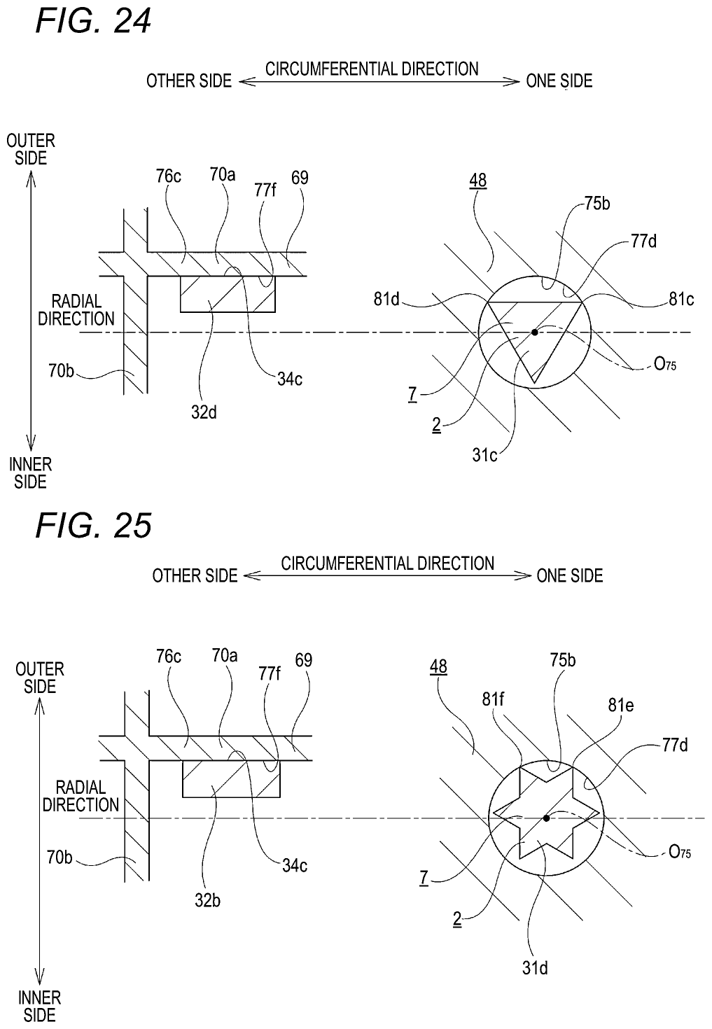

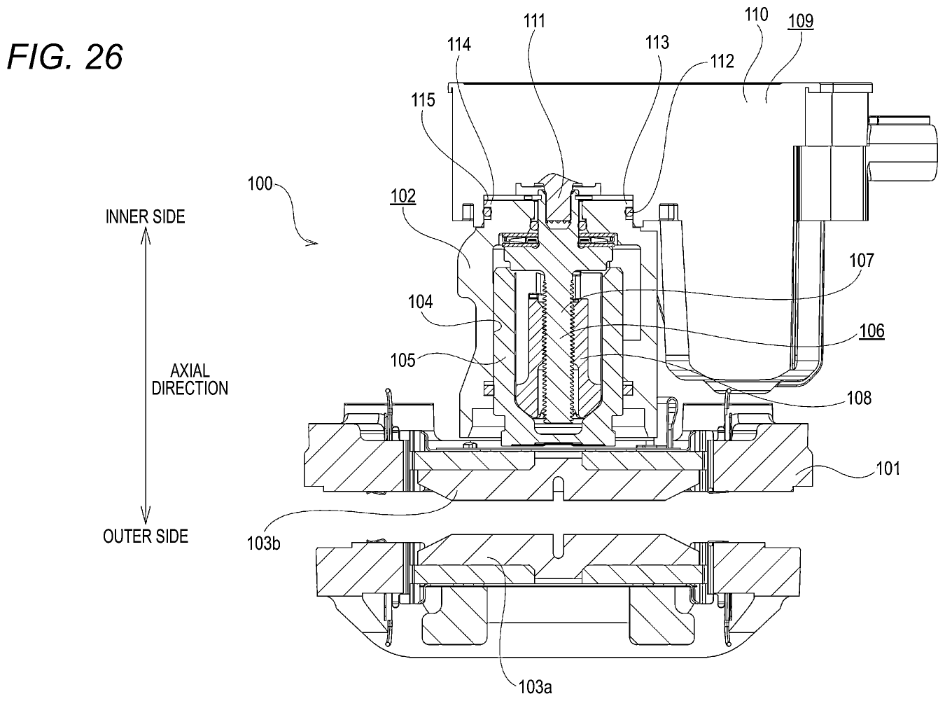

A ninth example of the embodiment will be described with reference to FIG. 24.

In the present example, only a structure of the first caliper-side restriction portion 31c is changed from a structure thereof in the eighth example of the embodiment. Structures of the second caliper-side restriction portion 32b, the first housing-side restriction portion 75b, and the second housing-side restriction portion 76c are the same as structures thereof in the eighth example of the embodiment.

In the present example, the first caliper-side restriction portion 31c is a triangular prism having a convex shape protruding in the axial direction from the housing facing surface 25. The first caliper-side restriction portion 31c includes a caliper-side restriction corner portion 81c that connects an outer surface in the radial direction and a side surface on one side in the circumferential direction, and a caliper-side restriction corner portion 81d that connects the outer surface in the radial direction and a side surface on the other side in the circumferential direction.

Also in the case of the present example, by inserting the first caliper-side restriction portion 31c into the first housing-side restriction portion 75b, the two caliper-side restriction corner portions 81c and 81d provided in the first caliper-side restriction portion 31c are brought into contact with the housing-side restriction surface 77d having a concave cylindrical surface shape provided on the inner peripheral surface of the first housing-side restriction portion 75b. As a result, a circumferential position and a radial position of each of the first caliper-side restriction portion 31c and the first housing-side restriction portion 75b are restricted.

In the case of the present example, when the first caliper-side restriction portion 31c is inserted into the first housing-side restriction portion 75b, the remaining corner portions connecting the side surface on the one side in the circumferential direction and the side surface on the other side in the circumferential direction of the first caliper-side restriction portion 31c can be lightly brought into contact with the housing-side restriction surface 77d. Other configurations, operations, and effects are the same as those of the first example and the eighth example of the embodiment.

### Tenth Example of Embodiment

A tenth example of the embodiment will be described with reference to FIG. 25.

In the present example, only a structure of the first caliper-side restriction portion 31d is changed from a structure thereof in the eighth example of the embodiment. Structures of the second caliper-side restriction portion 32b, the first housing-side restriction portion 75b, and the second housing-side restriction portion 76c are the same as structures thereof in the eighth example of the embodiment.

In the present example, the first caliper-side restriction portion 31d is a star-shaped prism having a convex shape protruding in the axial direction from the housing facing surface 25.

In the case of the present example, by inserting the first caliper-side restriction portion 31d into the first housing-side restriction portion 75b, at least two caliper-side restriction corner portions 81e and 81f provided on the portion on the outer side in the radial direction of the first caliper-side restriction portion 31d are brought into contact with the housing-side restriction surface 77d having a concave cylindrical surface shape provided on the inner peripheral surface of the first housing-side restriction portion 75b. As a result, a circumferential position and a radial position of each of the first caliper-side restriction portion 31d and the first housing-side restriction portion 75b are restricted.

In the case of the present example, when the first caliper-side restriction portion 31d is inserted into the first housing-side restriction portion 75b, other corner portions provided on the outer peripheral surface of the first caliper-side restriction portion 31d can be lightly brought into contact with the housing-side restriction surface 77d.

Other configurations, operations, and effects are the same as those of the first example and the eighth example of the embodiment.

Although the embodiments of the present disclosure have been described above, the structures in the examples of the embodiment can be appropriately combined and implemented as long as no contradiction occurs.

The structures of the caliper-side restriction portion and the housing-side restriction portion constituting the position restriction portion are not limited to the structures shown in each example of the embodiment, and can be appropriately modified.

In each example of the embodiment, a case where the caliper-side restriction portion and the housing-side restriction portion are provided in two each has been described, but the number of the caliper-side restriction portion and the number of the housing-side restriction portion are not limited to two. For example, the caliper-side restriction portion and the housing-side restriction portion may be provided in one each as long as the circumferential position, the radial position, and the relative rotation position can be simultaneously restricted by one caliper-side restriction portion and one housing-side restriction portion. For example, as such a caliper-side restriction portion and housing-side restriction portion, a structure is provided in which one of the caliper-side restriction portion and the housing-side restriction portion is formed in a prismatic shape such as a triangular prism or a quadrangular prism, and the other of the caliper-side restriction portion and the housing-side restriction portion is formed in a prismatic shape concave portion (prismatic hole) such as a triangular concave portion (triangular hole) or a quadrangular concave portion (quadrangular hole), and the caliper-side restriction portion and the housing-side restriction portion are fitted into each other without a gap.

In addition, respective installation positions of the caliper-side restriction portion and the housing-side restriction portion are not limited to the structure shown in each example of the embodiment, and the caliper-side restriction portion and the housing-side restriction portion can be installed at any position of the housing facing surface and the caliper facing surface.

What is claimed is:

1. A disc brake device comprising:
a caliper having a plurality of cylinders on an inner side in an axial direction with respect to a rotor;
a plurality of pistons fitted into the plurality of cylinders, respectively;
a plurality of rotation-linear motion conversion mechanisms that are disposed in the plurality of cylinders, that are configured to push out each of the plurality of pistons toward the rotor by converting a rotational motion into a linear motion, and that include rotation members and linear motion members;
a motor gear unit that is supported and fixed to the caliper and includes an electric motor, a plurality of output members disposed coaxially with the rotation members and configured to transmit rotation of the electric motor to the rotation members, the number of which is the same as the number of the rotation members, and a housing accommodating the electric motor and the plurality of output members;
a plurality of annular seals that are disposed coaxially with the rotation members and configured to perform sealing between the caliper and the housing, the number of which is the same as the number of the rotation members;
a position restriction portion configured to restrict a position of the motor gear unit with respect to the caliper; and
a fixing portion configured to fix the caliper and the housing, wherein
the annular seals are sandwiched in the axial direction between the caliper and the housing, and
the position restriction portion includes: at least one caliper-side restriction portion provided on the caliper, which is disposed non-coaxially with the rotation member and is configured to serve as a reference of a position of the rotation member; and at least one housing-side restriction portion provided on the housing, which is disposed non-coaxially with the output member and is configured to serve as a reference of a position of the output member, and is configured to restrict a position of the housing with respect to the caliper by bringing the caliper-side restriction portion and the housing-side restriction portion into contact with each other.

2. The disc brake device according to claim 1, wherein
the caliper-side restriction portion includes at least one caliper-side restriction surface having a curved surface shape or a flat surface shape,
the housing-side restriction portion includes at least one housing-side restriction surface having a curved surface shape or a flat surface shape, and
the caliper-side restriction portion and the housing-side restriction portion are configured to be brought into contact with each other by the caliper-side restriction surface and the housing-side restriction surface.

3. The disc brake device according to claim 1, wherein
one of the caliper-side restriction portion and the housing-side restriction portion includes at least one restriction corner portion,
the other of the caliper-side restriction portion and the housing-side restriction portion includes at least one restriction surface having a curved surface shape or a flat surface shape, and
the caliper-side restriction portion and the housing-side restriction portion are configured to be brought into contact with each other by the restriction corner portion and the restriction surface.

4. The disc brake device according to claim 1, wherein the caliper-side restriction portion and the housing-side restriction portion are provided in two each.

5. The disc brake device according to claim 4, wherein
by bringing a first caliper-side restriction portion of the two caliper-side restriction portions into contact with a first housing-side restriction portion of the two housing-side restriction portions, a circumferential position and a radial position of each of the first caliper-side restriction portion and the first housing-side restriction portion are restricted, and by bringing a second caliper-side restriction portion of the two caliper-side restriction portions into contact with a second housing-side restriction portion of the two housing-side restriction portions, a relative rotation position between the caliper and the housing about a central axis of the first caliper-side restriction portion or the first housing-side restriction portion is restricted.

6. The disc brake device according to claim 5, wherein
a contact direction of the second caliper-side restriction portion and the second housing-side restriction portion is a circumferential direction or a radial direction.

7. The disc brake device according to claim 1, wherein
the caliper-side restriction portion has a convex shape protruding in the axial direction.

8. The disc brake device according to claim 7, wherein
the caliper-side restriction portion is formed separately from the caliper, and includes a pin member configured to be fixed to the caliper.

9. The disc brake device according to claim 8, wherein
the caliper-side restriction portion is sandwiched and disposed between the caliper and the housing in the axial direction.

10. The disc brake device according to claim 1, wherein
the housing-side restriction portion is formed integrally with the housing.

11. The disc brake device according to claim 10, wherein
the housing-side restriction portion is provided in a part of a reinforcing rib integrally formed with the housing.

12. The disc brake device according to claim 10, wherein
the housing-side restriction portion has a concave shape recessed in the axial direction.

13. The disc brake device according to claim 1, wherein
the housing-side restriction portion is formed separately from the housing and includes a pin member configured to be molded and fixed to the housing.

14. The disc brake device according to claim 1, wherein
the fixing portion is a bolt.

15. A method for assembling the disc brake device according to claim 1, comprising:
bringing the caliper-side restriction portion and the housing-side restriction portion into contact with each other by utilizing gravity applied to the housing or the caliper.

16. A method for assembling the disc brake device according to claim 14, comprising:
bringing the caliper-side restriction portion and the housing-side restriction portion into contact with each other by utilizing a rotational force applied to the housing or the caliper from the bolt when tightening the bolt.
